(19) United States
(12) Patent Application Publication
(10) Pub. No.: US 2007/0168309 A1
(43) Pub. Date: Jul. 19, 2007

(54) System, method and computer program product for dynamically extracting and sharing event information from an executing software application

(75) Inventors: Yoav Tzruya, Even Yehuda (IL); Zvi Levgoren, Ganei-Tikva (IL); Itay Nave, Kfar Hess (IL)

Correspondence Address: FIALA & WEAVER, P.L.L.C., P.O. BOX 42736, WASHINGTON, DC, 20015, US

(73) Assignee: Exent Technologies, Ltd., Petach-Tikva (IL)

(21) Appl. No.: 11/545,733

(22) Filed: Oct. 11, 2006

Related U.S. Application Data
(63) Continuation-in-part of application No. 11/472,454, filed on Jun. 22, 2006.
Application No. 11/472,454 is a continuation-in-part of application No. 11/290,830, filed on Dec. 1, 2005.
(60) Provisional application No. 60/797,669, filed on May 5, 2006.

(51) Int. Cl. G06F 17/00

(52) U.S. Cl. 706/45

(57) ABSTRACT

A system, method and computer program product for dynamically extracting and sharing information indicative of the progress or performance of a user within a software application in an executing software application, such as a video game, without having to change and recompile the original application code or without having to add functionality into the source code. A server side environment is also described for building community features around such event information. A system, method and computer program product is further described for enhancing an executing software application by dynamically adding such event information to the executing application.

### CROSS-REFERENCE TO RELATED APPLICATIONS

This application is a continuation-in-part of U.S. patent application Ser. No. 11/472,454, filed Jun. 22, 2006, which claims the benefit of U.S. Provisional Patent Application No. 60/797,669 filed on May 5, 2006. U.S. patent application Ser. No. 11/472,454 is also a continuation-in-part of U.S. patent application Ser. No. 11/290,830 filed on Dec. 1, 2005. Each of the foregoing applications is incorporated by reference herein in its entirety.

### BACKGROUND OF THE INVENTION

1. Field of the Invention

The present invention generally relates to software applications. In particular, the present invention relates to techniques for dynamically extracting and sharing event information from a software application executing on a device.

2. Background Art

Software applications, and video games in particular, may include features that allow for communication with other remotely-executing instances of the software application and/or server side components to facilitate the creation of community-oriented features such as multi-player games, massively multi-player games, leader-boards and the like. One way to achieve this is to program these features into the original application logic, or “source code”. However, in order to do this, developers must pre-determine which events within the software application they wish to track and what information pertaining to those events they wish to share (e.g., how fast a user drove a car around a racing track in a racing simulation, or how many “bad guys” a user killed in a action game). If the monitoring and reporting of an event is not pre-programmed into the game, the information pertaining to that event will be lost and thus cannot be leveraged.

It is of interest to parties that make software applications available to end-users to be able to extract information relating to events occurring within the software applications so that the event information can be leveraged for various purposes. Such purposes may include: (a) measuring the extent that a given object or functionality is utilized within the software application to fine-tune product development; (b) creating community features around the software application, such as leader-boards, leagues, tournaments and such; and (c) allowing users to dynamically add objects or other content within the software application and allow other users to receive such objects or content for the purpose of enhancing their own experience with the software application. With respect to (c), the ability to add objects or other content may include leaving notes, hints, or providing some other means of communication from one user to another.

The above-mentioned parties may further wish to implement such functionality in a manner that permits the extraction and sharing of event information to be based on a dynamic set of “business rules”. Each business rule could provide event criteria which, if met, result in the extraction and sharing of information pertaining to the event. For example, the event criteria might be whether the application has rendered a “You won!” sign, and the event information might be information pertaining to a user winning a certain game session. Ideally, the dynamic nature of the business rules would allow them to be periodically changed. For example, it would be advantageous if one could define new types of events, event criteria, and event information to be extracted, thereby providing support for new and different types of information sharing. This can help keep users of the software application interested in participating in community events relating to the application.

It would be desirable if the extraction of event information included permitting a user of the software application to provide objects or other content for dynamic insertion into a remotely-executing instance of the software application. For example, the desired functionality might permit a user to add a landmark or a “sticky” note providing hints or puzzle solutions at a specified location within a video game such that other users can see this object if they wish to. It would further be desirable if, for each level of a video game, statistics could be extracted such as the time required to finish the level, the number of times the user died before completing the level, the state of the user's health meter when she finished the level, or the like. This information could then be sent to a server and can be published through various means, including via a web-site, or be made available to other users while they play the video game. In a further extension of event information extraction and sharing, it would be desirable if all users executing a video game at a certain time could “see” all other users that are currently executing the same game or are currently playing the same level in a game and allow the users to communicate using various messaging means within the context of the game.

One possible method of achieving the foregoing is to embed the business rules and related functionality directly in the original application logic and then recompile the application with those business rules and related functionality. However, this technique of coding and recompiling an application to accommodate the business rules might not be achievable for all software applications and may be time consuming to achieve. By way of example, the party wishing to insert the business rule or functionality might not have access to the source code. As another example, the application that is sought to be enhanced may already have been deployed in the field or purchased by consumers or others.

What is desired then is a system, method and computer program product for dynamically extracting and sharing event information from an executing software application, such as a video game, without having to change and recompile the original application code. Dynamically extracting and sharing event information should include the ability to dynamically define events, event criteria, and event information to be extracted to be extracted from the software application. Event information extraction should preferably include the ability of a user to create new objects or other content, as well as to define their own events, according to predefined or ad-hoc rules or to perform other functions relating to the executing application that are not provided for or invoked by the source code of the application. Such other functions should preferably include receiving objects and other content created by remote users and dynamically adding them within the executing application based on some criteria. What is also desired is a server-side environment that provides community features built around such extracted event information.

### BRIEF SUMMARY OF THE INVENTION

The present invention provides a system, method and computer program product for dynamically extracting and sharing information indicative of the progress or performance of a user within a software application (i.e., “event information”) from an executing software application, such as a video game, without having to change and recompile the original application code or without having to add functionality into the source code. The present invention also provides a server side environment for building community features around such event information. The present invention further provides a system, method and computer program product for dynamically enhancing an executing software application by adding such event information to the executing application.

A method for dynamically sharing information indicative of the progress or performance of a user within a software application executing on a local device in accordance with an embodiment of the present invention includes monitoring the software application during execution to determine if an event has occurred, wherein the event is indicative of the progress or performance of the user within the software application. Responsive to a determination that the event has occurred, information associated with the event is extracted and transmitted from the local device for use or viewing by another user. Monitoring the behavior of the software application during execution may include monitoring objects referenced or rendered by the application. Extracting information with the event may include permitting the user to generate content associated with the event. Transmitting the extracted information from the local device for use or viewing by another may include transmitting the extracted information to at least one server for use in providing community features to one or more remote users. The method may further include permitting the user to define an event, and extracting information associated with the user-defined event and transmitting the extracted information from the local device for use or viewing by another user.

The method may further include allowing the user to update the event outside of the game and may further allow users to “subscribe” to the “published” event information. Upon subscribing to such event information, the user indicating such subscription will be displayed with the events information related to the published content subscribed to.

A system in accordance with an embodiment of the present invention includes a processor and a memory in communication with the processor. The memory stores a plurality of instructions for directing the processor to execute a software application, monitor a behavior of the software application during execution to determine if an event has occurred, wherein the event is indicative of the progress or performance of the user within the software application, and extract information associated with the event and transmit the extracted information from the system responsive to a determination that the event has occurred. The plurality of instructions for directing the processor to monitor a behavior of the software application during execution may include a plurality of instructions for directing the processor to monitor objects referenced or rendered by the application. The plurality of instructions for directing the processor to extract information associated with the event may include a plurality of instructions for directing the processor to permit the user to generate content associated with the event. The plurality of instructions for directing the processor to transmit the extracted information from the system may include a plurality of instructions for directing the processor to transmit the extracted information to at least one server for use in providing community features to one or more remote users. The system may further include a plurality of instructions stored in the memory for directing the processor to permit the user to define an event, extract information associated with the user-defined event, and transmit the extracted information from the local device for use or viewing by another user.

A method for providing community features associated with a software application in accordance with an embodiment of the invention includes storing event information received from a plurality of remotely-executing instances of the software application in a database, wherein the event information is inferentially derived through monitoring the execution of the remotely-executing instances of the software application, and executing an application that facilitates access to the event information by a plurality of remote users. Executing the application may include executing a Web interface, executing a community features engine, providing leader boards or a high score table based on the event information, permitting two or more of the plurality of remote users to compete in a tournament, permitting league play between two or more of the plurality of remote users, permitting a remote user to access event information for use in augmenting a web-page. Storing the event information may comprise storing user-generated content and executing the application may comprise permitting a remote user to access the user-generated content for dynamically enhancing a remotely-executing instance of the software application.

A system for providing community features associated with a software application in accordance with the present invention includes a database configured to store event information received from a plurality of remotely-executing instances of the software application, wherein the event information is inferentially derived through monitoring the execution of the remotely-executing instances of the software application. The system further includes at least one server configured to execute an application that facilitates access to the event information by a plurality of remote users. The application may comprise a Web interface or a community features engine. The application may be configured to provide leader boards or a high score table based on the event information, to permit two or more of the plurality of remote users to compete in a tournament, to permit league play between two or more of the plurality of remote users, to permit a remote user to access event information for use in augmenting a web-page. The event information may include user-generated content and the application may be configured to permit a remote user to access the user-generated content for dynamically enhancing a remotely-executing instance of the software application.

A method for dynamically-enhancing an instance of a software application executing on a local device in accordance with an embodiment of the present invention includes receiving information indicative of events generated as a result of the progress or performance of a remote user in a remotely-executing instance of the software application, in real-time or in retrospect, and dynamically augmenting graphics or audio content generated by the locally-executing instance of the software application based on the received information. Receiving information may include receiving content created by the remote user and dynamically augmenting graphics or audio content generated by the locally-executing instance of the software application may include inserting the received content into a graphics or audio object rendered or referenced by the locally-executing instance of the software application.

A system in accordance with an embodiment of the present invention includes a processor and a memory in communication with the processor. The memory stores a plurality of instructions for directing the processor to execute an instance of a software application, receive information indicative of the progress or performance of a remote user in a remotely-executing instance of the software application, and dynamically augment graphics or audio content generated by the locally-executing instance of the software application based on the received information. The plurality of instructions for directing the processor to receive information may include a plurality of instructions for directing the processor to receive content created by the remote user and the plurality of instructions for directing the processor to dynamically augment graphics or audio content generated by the locally-executing instance of the software application may include a plurality of instructions for directing the processor to insert the received content into a graphics or audio object rendered or referenced by the locally-executing instance of the software application.

Further features and advantages of the present invention, as well as the structure and operation of various embodiments thereof, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 illustrates an exemplary system for dynamically extracting and sharing information indicative of the progress or performance of a user within a software application in accordance with an embodiment of the present invention.

FIG. 2 depicts a flowchart of a method for dynamically extracting and sharing information indicative of the progress or performance of a user within a software application in accordance with an embodiment of the present invention.

FIG. 3 depicts the hardware components of a system that monitors objects referenced or rendered by an application to facilitate the dynamic extraction and sharing of event information in accordance with an embodiment of the present invention.

FIG. 4 illustrates the software components of a system that monitors objects referenced or rendered by an application to facilitate the dynamic extraction and sharing of event information in accordance with an embodiment of the present invention.

FIG. 5 illustrates a conventional software architecture for a Microsoft® Windows® based PC that utilizes graphics libraries.

FIG. 6 illustrates a software architecture of a staging environment that includes emulated graphics and audio libraries, comprising components for indexing graphics and audio objects, in accordance with an embodiment of the present invention.

FIG. 7 illustrates a flowchart of a method used in a staging environment for facilitating the dynamic reporting and sharing of user achievement information in accordance with an embodiment of the present invention.

FIG. 8 illustrates a software architecture of a run-time environment that includes emulated graphics and audio libraries, comprising components that identify graphics and audio objects and apply business rules associated with the identified objects, in accordance with an embodiment of the present invention.

FIG. 9 illustrates a flowchart of a method used in a run-time environment for dynamically extracting and sharing of event information in accordance with an embodiment of the present invention.

FIG. 10 illustrates a network system for distributing and/or accessing software components in accordance with an embodiment of the present invention.

FIG. 11 depicts an example computer system in which an embodiment of the present invention may be implemented.

FIGS. 12A and 12B illustrate an object tagging component and an object measurement component useful for dynamically tracking and determining the impact of objects rendered and/or referenced by an application, without having to change and recompile the original application code, according to an embodiment of the invention.

FIG. 13 illustrates a flowchart of a method for dynamically tracking and determining the impact of objects rendered and/or referenced by an application, without having to change and recompile the original application code, according to an embodiment of the invention.

FIG. 14 illustrates a flowchart of a method used in a staging environment for tagging objects of interest, according to an embodiment of the invention.

FIG. 15 illustrates a flowchart of a method used in a run-time environment for tracking and determining the impact of an object of interest, according to an embodiment of the invention.

FIG. 16 illustrates a flowchart of a method used in a run-time environment for tracking and determining the impact of an object of interest, according to an alternative embodiment of the invention.

FIG. 17 is a flowchart illustrating a process for determining, measuring and/or collecting attribute information of an object of interest, according to an embodiment of the invention.

FIG. 18 illustrates an example of a flowchart of a method used in a run-time environment illustrating measurement criteria used to determine, measure and/or collect attribute information of an object of interest, according to an embodiment of the invention.

FIG. 19 is an example scene illustrating the manner in which an object (a camel) can be manually selected for subsequent tracking and measuring, according to an embodiment of the invention.

FIG. 20 is a flowchart illustrating an example embodiment for measuring exposure of an object using DirectX.

FIG. 21 is a flowchart of a method for publishing and subscribing to user-generated content associated with an event in accordance with an embodiment of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### I. System Overview

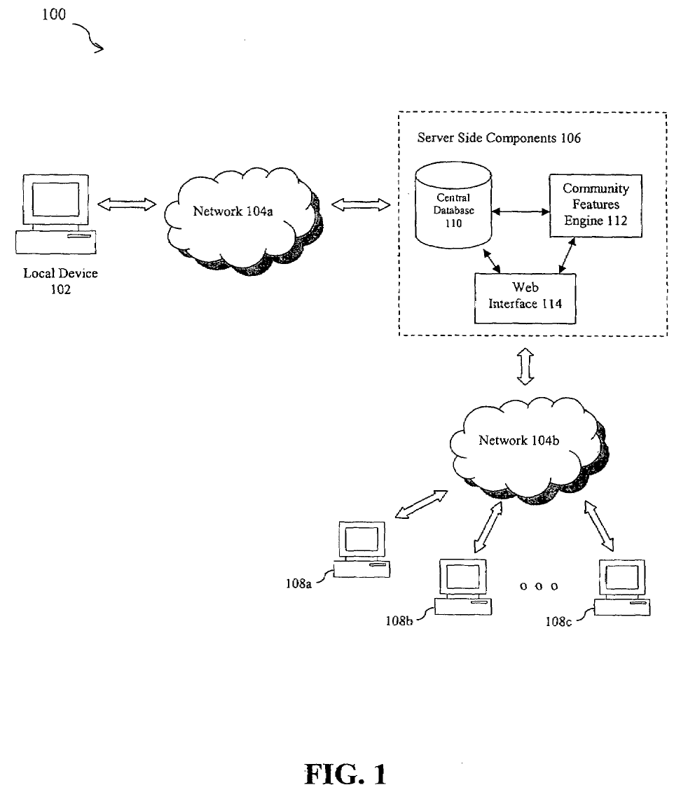

FIG. 1 illustrates an exemplary system 100 for dynamically extracting and sharing information indicative of the progress or performance of a user within a software application in accordance with an embodiment of the present invention. As shown in FIG. 1, system 100 includes a local device 102. Local device 102 may comprise a personal computer (either desktop or laptop), a server, a video game console, a personal digital assistance (PDA), a cellular phone, or any other type of device that is capable of executing software applications. As is further shown in FIG. 1, local device 102 is communicatively connected to one or more server side components 106 via a data communication network 104a. Data communication network 104a may comprise, for example, the Internet. However, the invention is not so limited, and data communication network 104a may comprise any type of data communication network, including local and/or wide area networks, as well as wired and/or wireless networks.

As further shown in FIG. 1, server side components 106 include a central database 110, a community features engine 112 and a web interface 114. Each of server side components 106 may be jointly or individually implemented on one or more servers, or on devices communicatively connected to one or more servers, in accordance with this embodiment of the present invention. Server side components are further communicatively connected to a plurality of remote devices 108a, 108b and 108c via a data communication network 104b. Like data communication network 104a, data communication network 104b may comprise any type of data communication network, including local and/or wide area networks, as well as wired and/or wireless networks. In one implementation, data communication network 104b is the same network or part of the same network as data communication network 104a.

Like local device 102, remote devices 108a, 108b and 108c may each comprise a personal computer, a server, a console, a personal digital assistance (PDA), a cellular phone, or any other type of device that is capable of executing software applications. In one implementation, one or more of remote devices 108a, 108b and 108c is the same type of device as local device 102, although the invention is not so limited. For example, in one implementation, local device 102 and each of remote devices 108a, 108b and 108c comprises a personal computer.

A. Event Monitoring and Information Extraction on Local Device

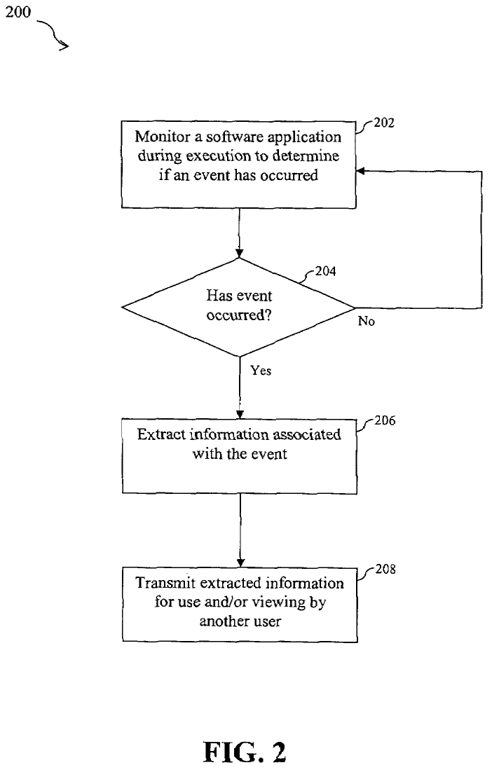

As will be described in more detail herein, local device 102 is configured to monitor an executing software application, such as a video game, to determine if an event has occurred, wherein the event is indicative of a user's progress or performance within the software application. If the event occurs, local device 102 is further configured to extract information associated with the event and transmit it for viewing and/or use by other users. This functionality will now be described with reference to flowchart 200 of FIG. 2, which describes a general method for dynamically extracting and sharing information indicative of the progress or performance of a user within a software application in accordance with an embodiment of the present invention.

The method begins at step 202 in which local device 102 monitors a software application, such as a video game, during execution to determine if an event has occurred, wherein the event is indicative of the progress or performance of the user within the software application. For example, the event may be indicative of a particular user achievement within the software application, such as finishing a particular race within a racing simulation game, or completing a level within a “first-person shooter” type combat game. As another example, the event may be the rendering of a “You won!” sign in the game, denoting that the user has won a certain game session. In accordance with embodiments described herein, what constitutes an event within the software application may be dynamically defined by a system administrator, other entity, or by the user herself.

Monitoring for the occurrence of an event may include tracking one or more logical and/or physical states within an operating environment of local device 102 and inferentially determining that the event has occurred based on one or more state changes. As will be described in more detail herein, in accordance with one implementation of the present invention, such monitoring comprises monitoring objects, such as graphics and/or audio objects, rendered or otherwise referenced by the software application during execution. Regardless of the approach, the software application itself does not determine that the event has occurred. Rather, one or more additional components are installed on local device 102 to monitor execution of the application and to make such a determination.

As shown at decision step 204, if the event has not yet occurred, control returns to step 202 and local device 102 continues to monitor the executing application. However, if the event has occurred, then local device 102 extracts information associated with the event as shown at step 206 and transmits the extracted information for use and/or viewing by another user as shown at step 208. For example, information concerning how fast a race was finished within a racing simulation game or how many “bad guys” were killed by a user when completing a level in a first-person-shooter may be extracted and transmitted. In accordance with another example, for each level of a game that is completed, statistics may be extracted that include parameters such as the time required to finish the level, the number of times the user died before completing the level, the state of the user's health meter at the time the level was finished, or the like.

Like the event monitoring steps 202 and 204, the information extraction and transmission steps 206 and 208 are handled by logic external to the source code of the software application executing on the local device.

Because the steps of flowchart 200 are performed by elements external to the software application, the foregoing approach provides flexibility in terms of dynamically determining which events should be monitored for and what type of event information should be extracted. In other words, because the event monitoring and information extraction features are not required to be part of the original software application source code, there is no need to determine which events should be monitored for and what type of event information should be extracted prior to releasing the software application. Rather, these determinations can be made after the software has been released and dynamically changed as needed depending on the desired use of the event information.

A particular method by which local device 102 monitors for events and extracts information relating to events is described in great detail below in Section II.

B. Provision of Community Features by Server Side Components

In one implementation of the present invention, the event information extracted by local device 102 is transmitted to server side components 106 where it is stored in central database 110 and is accessible to community features engine 112 and web interface 114. As such, the event information can be used alone or along with other types of information, such as manually- or automatically-generated data, to support community features, such as leader-boards, leagues, tournaments and such. In particular, community features applications may be provided “on top of” the event information that allow users, such as the users of remote devices 108a, 108b and 108c, to be part of a community of interest around a software application, and allow users to access and view information concerning the activities and achievements of other users in various software applications. Users of remote devices 108a, 108b and 108c may access the community features via web interface 114.

Such community features applications may include the provision of leader boards and/or a high score table based on the event information stored in central database 110.

Such community features applications may enable tournaments that allow users to compete against one another for prizes. The tournaments may be head-to-head in the sense that a user competes to defeat or win money from other users. Alternatively, the tournaments may pit one or more users against the house.

Such community features applications may also support league play in which users are allowed to achieve a higher ranking based on their achievements. League participation may be based on geographic region, skill levels, and/or some other grouping criteria. Additionally or alternatively, the criteria for league participation may be user-determined.

Such community features applications may permit users to access the event information in central database 110 for use in augmenting personal web-pages, such as for bragging or blogging. For example, such information may be accessed so that it can be used to show a user's achievements on a user's web-page or to otherwise personalize his or her web-page.

Such community features applications may provide automatic help creation or brokering. For example, such applications may automatically connect users and allow them to communicate with users who are more advanced in order to obtain know-how as to how to progress in the game. The determination of a user's the level of advancement in the game would be based on the event information stored in central database 110.

Such community features applications may include a game search engine that allows users to look for other users and/or other items of data (e.g., a screen snapshot of an event) based on the event information stored in central database 110. For example, the game search engine could be used to allow a user to search for all users that possess a certain weapon in a particular game, in order to try and trade with them.

Such community features applications may include features that enable a user to view a subset of the available event information based on one or more filters such as personal filters (e.g., user name or e-mail address), achievement-related filters (e.g., users that have achieved the greatest level of advancement, score or ranking within a game), or other filters.

The foregoing examples of community-building applications are provided by way of example only and are not intended to limit the present invention.

C. Dynamic Enhancement of Software Applications Executing on Remote Devices

In one implementation of the present invention, the extraction of event information from local device 102 includes allowing a user to dynamically add objects within the context of the software application. These dynamically-added objects can then be received by another user for enhancing instantiations of the same software application running on a remote device. Such dynamically-added objects may include notes, hints or other means of passing information from one user to another which can be viewed within the context of an executing software application. For example, a user may add a landmark into a video game at a certain location in the game and allow other users to see this object if they wish to. In accordance with another example, once a user figures out how to advance to a next level within a video game, the user may leave a note attached to a certain location in the game describing the solution for other users. The note may be attached to an object that is selected by the user or may be automatically attached to a graphics object based on calculations performed by an embodiment of the present invention. For example, the note may be automatically attached to a graphics object based on a calculation of the proximity to the largest graphics object in the scene.

In an embodiment of the present invention, the dynamically-added objects are received by server side components 106 and stored in central database 1 10. Access to such objects is then made available to other users through the operation of community features engine 112 and web interface 114. In an alternate embodiment, the dynamically-added objects are immediately passed by server side components 106 to one or more of remote devices 108a, 108b, and 108c via a data communication network. Where the dynamically-added objects are stored in central database 110, a user may be provided an interface by which to elect to receive particular dynamically-added objects for download and use in augmenting a particular software application.

The insertion of the dynamically-added objects into software applications executing on remote devices 108a, 108b or 108c is not handled by the software applications themselves. Rather, additional software components are installed on the remote devices that monitor and detect the occurrence of events in a like manner to the software components installed on local device 102. A particular method of event monitoring and detection is described in great detail below in Section II. When an event with which the dynamically-added object is associated is detected by a remote device, the dynamically-added object is then inserted into the software application during execution for viewing by the remote user.

As will be readily understood by persons skilled in the art based on the teachings provided herein, the information that may be passed between users of a particular software application in the manner described above is not limited to objects, but may also include any type of content which can be passed by any means of communication between users. For example, the content may be any type of messaging that can occur between users or may be any type of information that could otherwise be published by the server side components 106. The option to receive such information may extend to all currently on-line users or to any user that has ever reported progress or performance within a software application.

For example, in accordance with one implementation of the present invention, all users that are executing a particular software application at a certain time are provided with an identification of all other users that are currently executing the same software application and/or the same level within the software application. The users may then communicate using one or more messaging functions that are made available within the context of the software application. For example, text chat, voice chat or video chat functionality may be used to exchange messages between the users.

Furthermore, in accordance with another implementation of the present invention, the user of a remote device can receive within the executing software application an indication of the progress or performance of other users within the software application. This information can be made available within the context of the software application in various ways, such as via graphic display somewhere on the screen (e.g., a pop-up window). The information may be presented to the user responsive to a use of a certain key combination by the user, responsive to the information becoming available, or relevant to the user's own progress or performance within the software application.

Because each of the foregoing features is carried out by software components external to the software application executing on a remote device, these features can be advantageously implemented without the need to add additional functionality into the source code of the software application.

### II. Event Detection and Information Extraction in Accordance with an Embodiment of the Present Invention

As described above, local device 102 of FIG. 1 is configured to monitor a software application during execution to determine if an event has occurred, wherein the event is indicative of the progress or performance of a user within the software application. Such monitoring may include tracking one or more logical and/or physical states within an operating environment of local device 102 and inferentially determining that the event has occurred based on one or more state changes. Regardless of the approach, the software application itself does not determine that the event has occurred. Rather, one or more additional components are installed on local device 102 to monitor execution of the application and to make such a determination.

In accordance with one implementation of the present invention, monitoring the software application during execution to determine if an event has occurred comprises monitoring objects, such as graphics and/or audio objects, rendered or otherwise referenced by the software application during execution. An association between one or more objects and certain event criteria is predefined, such that if the one or more objects meet the event criteria, the event is deemed to have occurred. The event criteria may be as straightforward as detecting the generation of the one or more objects by the software application. Alternatively, the event criteria may be based on a measured impact of the one or more objects or some other criteria associated with the one or more objects. As will be described in more detail herein, the definition of event criteria may be provided by a system administrator or other entity or by the user of the software application herself.

Once the event is deemed to have occurred, a business rule is implemented that includes extracting information associated with the event and transmitting the extracted information to a remote location for use and/or viewing by another user. A particular example of such an implementation will now be described. However, it should be noted that this implementation is described by way of example only and is not intended to limit the present invention.

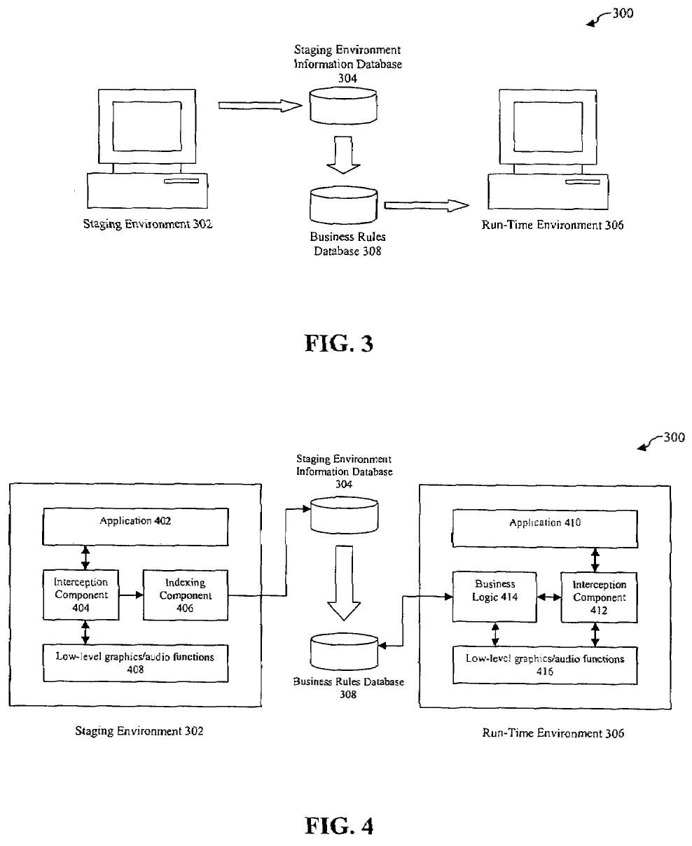

FIG. 3 depicts the hardware components of a system 300 that monitors objects rendered or referenced by an application to facilitate the dynamic extraction and sharing of event information in accordance with an embodiment of the present invention. As shown in FIG. 3, system 300 includes both a staging environment 302 and a run-time environment 306. In one implementation, run-time environment 306 is intended to represent local device 102 of system 100, described above in reference to FIG. 1.

Staging environment 302 is used by a system administrator or other entity to perform processing steps that must occur to facilitate operations that will later be performed on behalf of a user in run-time environment 306. In particular, and as will be explained in more detail herein, staging environment 302 is used by a system administrator or other entity to monitor a software application, such as a video game, during execution, to identify certain graphics and audio objects generated by the application, and to store each of these objects (and/or a unique identifier (ID) associated with each object) in a staging environment information database 304. Staging environment 302 also allows the system administrator or other entity to define event criteria associated with one or more of the identified objects, wherein satisfaction of the event criteria means that an event has occurred. An event is an occurrence within the software application that is indicative of the progress or performance of a user within the software application. The event criteria is also stored in staging environment information database 304.

After staging environment information database 304 has been populated, the system administrator or other entity then populates a business rules database 308 by manual or automated means with a set of “business rules”, wherein at least some of the business rules stored in database 308 are associated with event criteria stored in staging environment information database 304.

Run-time environment 306 represents the environment in which an end-user actually runs the application software. The application is the “same” as the application executed in staging environment 302 in that it is another copy or instance of essentially the same computer program, although it need not be completely identical. As will be described in more detail herein, run-time environment 306 monitors the execution of the application on a device and also identifies, tracks and/or measures application-generated graphics and audio objects. If run-time environment 306 determines that an identified object or objects generated by the application meets event criteria associated with a business rule in business rules database 308, then it applies the associated business rule. The business rule may be used, for example, to extract information associated with the event and to transmit the extracted information to a remote device for use and/or viewing by another user.

In terms of hardware components, each of staging environment 302 and run-time environment 306 consists of a device that is configured to execute software applications that generate graphics and audio information. Each device further includes application program interfaces for rendering and displaying the application-generated graphics information and for playing back the application-generated audio information. For the sake of convenience, for the remainder of this section, each of staging environment 302 and run-time environment 306 will be described as comprising a personal computer (PC) based computer system, although the invention is not so limited. For example, staging environment 302 and run-time environment 306 may each comprise a server, a console, a personal digital assistant (PDA), a cellular telephone, or any other device that is capable of executing software applications and displaying associated application-generated graphics and audio information to an end-user.

A. Staging Environment

FIG. 4 illustrates the software components of system 300. As shown in FIG. 4, staging environment 302 includes an application 402, an interception component 404, an indexing component 406, and low-level graphics/audio functions 408. Application 402 is a software application, such as a video game, that is executed within staging environment 302. Low-level graphics/audio functions 408 are software functions resident in memory of the computer system that are accessible to application 402 and that assist application 402 in the rendering of application-generated graphics information and the playing of application-generated audio information. In an embodiment, low-level graphics/audio functions 408 comprise one or more functions within a low-level application program interface (API) such as DirectX® or OpenGL®.

Application 402 is programmed such that, during execution, it makes function calls to low-level graphics/audio functions 408. The interaction of application 402 with low-level graphics/audio functions 408 is well-known in the art. However, in accordance with an embodiment of the present invention, such function calls are intercepted by interception component 404 and provided to an indexing component 406 prior to being passed to low-level graphics/audio functions 408. Interception component 404 and indexing component 406 are software components that are installed on the computer system of staging environment 302 prior to execution of application 402. As will be described in more detail herein, indexing component 406 identifies graphics and audio objects associated with the intercepted function calls and stores each of the objects (and/or a unique ID associate with each of the objects) in staging environment information database 304.

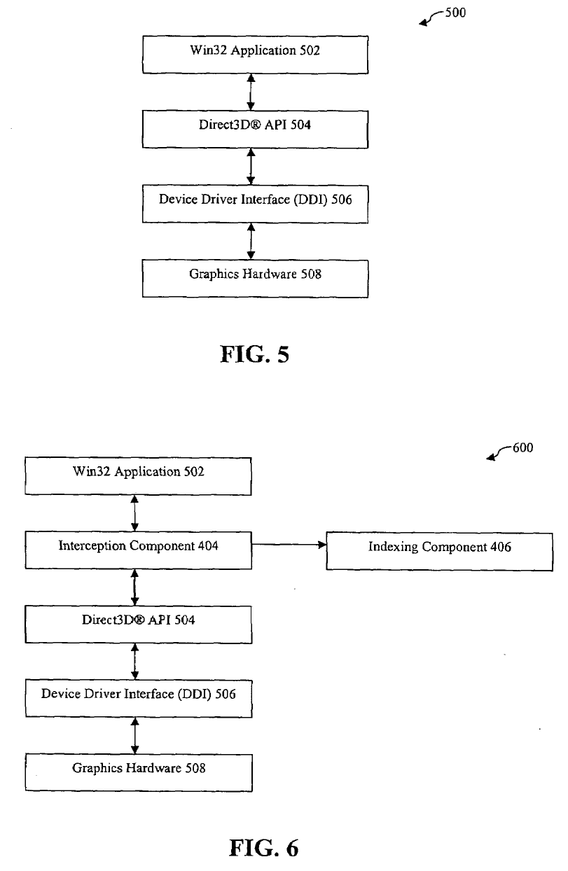

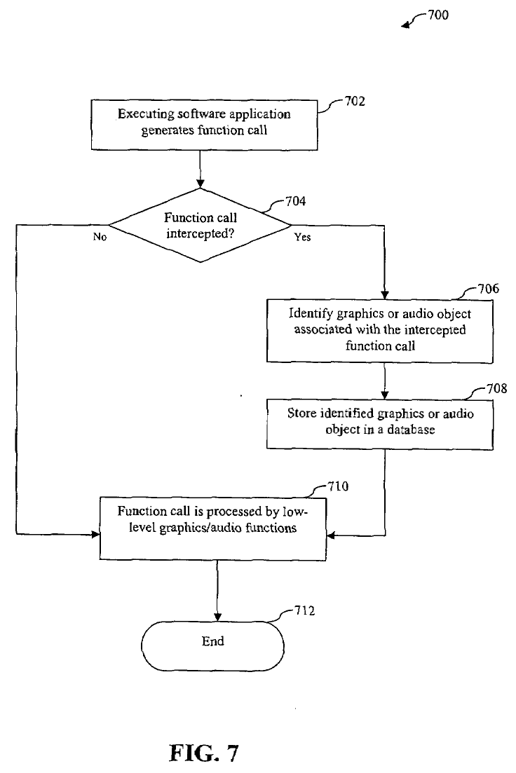

In an implementation of the present invention, interception component 404 comprises one or more emulated versions of corresponding low-level graphics/audio functions 408. For example, in an implementation in which low-level graphics/audio functions 408 are contained in graphics and audio libraries (such as in dynamic link libraries, or DLLs), interception component 404 comprises emulated versions of one or more of those libraries. A particular example of interception by emulation will now be explained with reference to FIGS. 5 and 6.

FIG. 5 illustrates a conventional software architecture 500 for a Microsoft® Windows® based PC. As shown in FIG. 5, software architecture 500 includes a 32-bit Microsoft® Windows® application 502 executing on the PC. During execution, application 502 makes function calls to a Direct3D® API 504 in a well-known manner. As will be appreciated by persons skilled in the relevant art(s), Direct3D® API 504 comprises a series of libraries that are resident in PC memory and accessible to application 502 and that include functions that may be called by application 502 for rendering and displaying graphics information. In response to receiving the function calls from application 502, Direct3D® API 504 determines if such functions can be executed by graphics hardware 508 within the PC. If so, Direct3D® API 504 issues commands to a device driver interface (DDI) 506 for graphics hardware 508. DDI 506 then processes the commands for handling by graphics hardware 508.

In contrast to the conventional software architecture illustrated in FIG. 5, FIG. 6 illustrates a software architecture including emulated graphics and audio libraries in accordance with an embodiment of the present invention. As shown in FIG. 6, interception component 404 has been inserted between application 502 and Direct3D® API 504. This may be achieved by emulating one or more graphics or audio libraries within Direct3D® API 504. As a result, certain function calls generated by application 502 are received by interception component 404 rather than Direct3D® API 504. Interception component 404 provides the intercepted function calls, and/or graphics and audio objects associated with the intercepted function calls, to an indexing component 406. Interception component 404 also passes the function calls to Direct3D® API 504 by placing calls to that API, where they are handled in a conventional manner. It is noted, however, that the function calls need not necessarily be passed to Direct3D® API 504 in order to practice the invention.

Depending on the operating system, emulating a genuine graphics API can be achieved in various ways. One method for emulating a genuine graphics API is file replacement. For example, since both DirectX® and OpenGL® are dynamically loaded from a file, emulation can be achieved by simply replacing the pertinent file (OpenGL.dll for OpenGL® and d3dX.dll for DirectX®, where X is the DirectX® version). Alternatively, the DLL can be replaced with a stub DLL having a similar interface, which implements a pass-through call to the original DLL for all functions but the hook functions.

Another method that may be used is to intercept or “hook” function calls to the API using the Detours hooking library published by Microsoft® of Redmond, Wash. Hooking may also be implemented at the kernel level. Kernel hooking may include the use of an operating system (OS) ready hook to enable a notification routine for an API being called. Another technique is to replace the OS routines by changing the pointer in the OS API table to a hook routine pointer, thereby chaining the call to the original OS routine before and/or after the hook logic execution. Another possible method is an API-based hooking technique that performs the injection of a DLL to any process that is being loaded, by setting a system global hook or by setting a registry key to load such a DLL. This injection is done only to have the hook function running in the process address space. While the OS loads such a DLL, a DLL initialization code changes the desired DLL dispatch table. Changing the table causes the pointer to the original API implementation to point to the DLL implementation (only to the desired API) and thus hooking the API. Hooking techniques are described, for example, at the web page http://www.codeguru.com/system/apihook.html. Note that the above described hooking techniques are presented only by way of example, and are not meant to limit the invention to any of these techniques. Other tools and methods for intercepting function calls to graphics or audio APIs are known to persons skilled in the relevant art(s).

FIG. 7 illustrates of a flowchart 700 of certain processing steps carried out by staging environment 302 with respect to the handling of a single graphics or audio function call generated by a single software application. Persons skilled in the relevant art(s) will readily appreciate that a software application will likely generate numerous such function calls, and thus that the method of flowchart 700 may be carried out numerous times during execution of the software application.

The method begins at step 702, in which software application 402 generates a function call directed to low-level graphics/audio functions 408. At step 704, it is determined whether or not the function call is intercepted by interception component 404. If no interception occurs, then processing proceeds to step 710, where the function call is handled by low-level graphics/audio functions 408 in a conventional manner. Processing of the function call then ends as indicated at step 712. However, if the function call has been intercepted, processing instead proceeds to step 706.

At step 706, interception component 404 identifies a graphics or audio object associated with the intercepted function call. A graphics object may comprise a model, texture, image, parameter, or any other discrete set of information or data associated with the intercepted function call and used in rendering graphics information on behalf of application 402. An audio object may comprise an audio file, a digital sound wave, or any other discrete set of information or data associated with the intercepted function call and used in playing back audio information on behalf of application 402. The graphics or audio object may be part of the function call itself or may be addressed by or pointed to by the function call. For example, if the intercepted function call is a SetTexture function call to the Direct3D® API, the associated graphics object may consist of a texture pointed to by the SetTexture function call.

At step 708, indexing component 406 stores the graphics or audio object identified in step 706 in staging environment information database 304. In one implementation, storing the object includes storing the object, or a portion thereof, in staging environment information database 304 along with a unique identifier (ID) for the object. The unique ID may be arbitrarily assigned or may be calculated based on information contained in the object itself. For example, in an implementation, the unique ID comprises an error correction code, such as a cyclic redundancy code (CRC), that is calculated based on all or a portion of the content of the graphics or audio object. In an alternate implementation, an encryption and/or hashing algorithm is applied to all or a portion of the content of the graphics or audio object to generate the unique ID. For example, the unique ID may be an MD5 hash signature that is calculated based on all or a portion of the content of the graphics or audio object.

At step 710, after storing is complete, the function call is then passed to low-level graphics/audio functions 408, where it is handled in a conventional manner. After this, processing of the function call ends as indicated at step 712.

The foregoing description of the method of flowchart 700 assumes that each of the software components of staging environment 302 have already been installed on a computer system. The method also assumes that software application 402 is executing on the computer system. Executing software application 402 encompasses both launching the application and interacting with the application through one or more user interfaces in a manner that causes the application to generate graphic and/or audio information. For example, if application 402 is a video game, executing the application encompasses both launching the video game and playing through at least a portion of the video game using appropriate user input/output (I/O) devices.

As noted above, after the graphics and/or audio objects have been stored in staging environment information database 304, the system administrator or other entity defines event criteria associated with one or more of the identified objects, wherein satisfaction of the event criteria means that an event has occurred. An indication of the association between the event criteria and the one or more objects is also stored in staging environment information database 304. After staging environment information database 304 has been populated, the system administrator or other entity then populates a business rules database 308 by manual or automated means with a set of “business rules”, wherein at least some of the business rules stored in database 308 are associated with event criteria stored in staging environment information database 304.

In one implementation, staging environment information database 304 is created or populated in local memory of the computer system of staging environment 302. The system administrator or other entity then populates business rules database 308 by manual or automated means with one or more business rules, wherein each business rule is associated with one or more of the event criteria stored in the first database. The association between the business rule and event criteria may be created by forming a relationship between the business rule and the unique ID of the object or objects associated with the event criteria in database 308. In one implementation, a “wild card” scheme is used to permit a single business rule to be associated with a group of logically-related objects.

B. Run-Time Environment

As shown in FIG. 4, the software components of run-time environment 306 include an application 410, an interception component 412, business logic 414, and low-level graphics/audio functions 416. Application 410 is the “same” as application 402 of staging environment 302 in that it is another copy or instance of essentially the same computer program, although it need not be completely identical. Low-level graphics/audio functions 416 are software functions resident in memory of the computer system that are accessible to application 410 and that assist application 410 in the rendering of application-generated graphics information and the playing of application-generated audio information. Low-level graphics/audio functions 408 and 416 are similar in the sense that they provide the same functionality and services to application 402 and application 410, respectively, through similar APIs.

During execution on the computer system of run-time environment 306, application 410 makes function calls to low-level graphics/audio functions 416 in the same well-known manner that application 402 made function calls to low-level graphics/audio functions 408 in staging environment 302. However, in accordance with an embodiment of the present invention, such function calls are intercepted by interception component 412, which either passes the function call on to low-level graphics/audio functions 416, on to business logic 414, or both. Interception component 412 and business logic 414 are software components that are installed on the computer system of run-time environment 306 prior to execution of application 410.

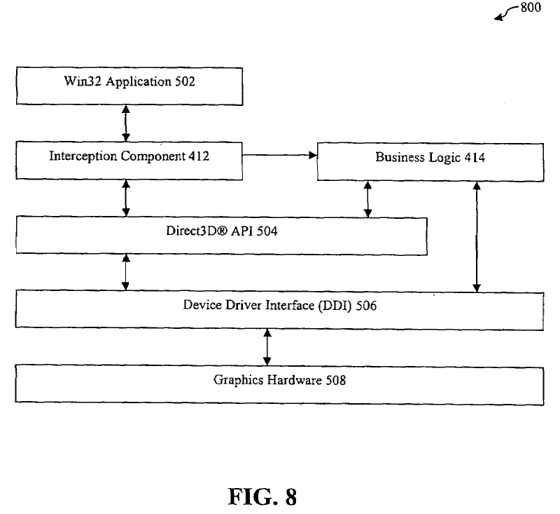

FIG. 8 illustrates an example software architecture for run-time environment 306 in which interception component 412 is implemented by way of emulation. As shown in FIG. 8, interception component 412 has been inserted between a Windows application 502 and a Direct3D® API 504. Like the software architecture described above with reference to FIG. 6, this is achieved by emulating one or more graphics or audio libraries within Direct3D® API 504. As a result, certain function calls generated by application 502 are received by interception component 412 rather than Direct3D® API 504. As also shown in FIG. 7, in an implementation, both interception component 412 and business logic 414 can place function calls to Direct3D® API 504 and business logic 414 can send commands directly to DDI 506. Whether or not business logic 414 requires this capability will depend upon the nature of the business rules being applied.

When interception component 412 intercepts a function call, it passes control, along with a relevant object to business logic 414, which determines if the object is associated with event criteria stored in business rules in database 308. If the object is associated with event criteria stored in business rules database 308, then business logic 414 determines if the event criteria has been met, and if so, applies a business rule associated with the event. The intercepted function call is then passed on to low-level graphics/audio functions 416.

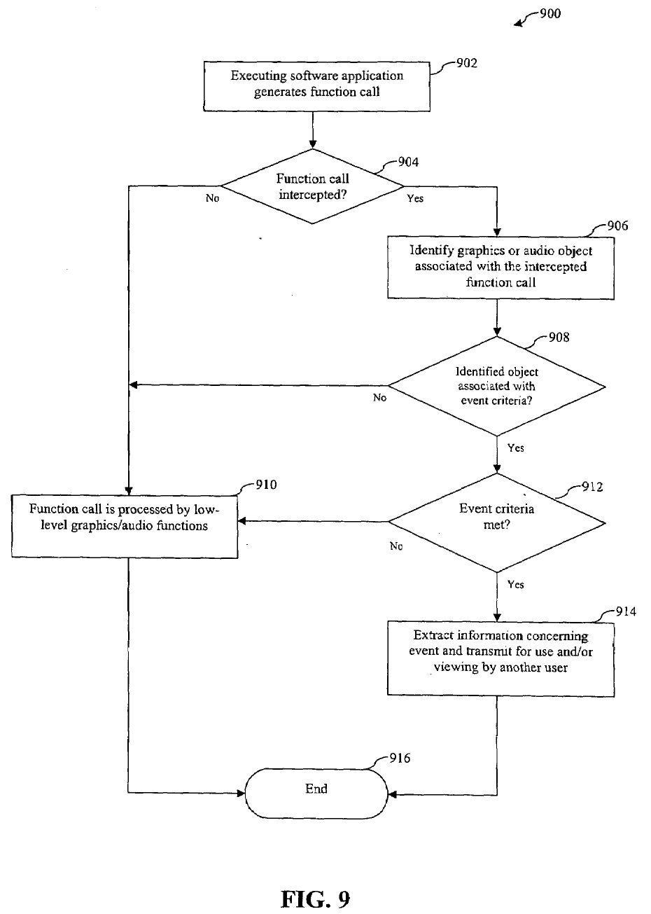

FIG. 9 illustrates a flowchart 900 that describes the processing steps carried out by run-time environment 306 with respect to the handling of a single graphics or audio function call generated by a single software application. Persons skilled in the relevant art(s) will readily appreciate that a software application will likely generate numerous such function calls, and thus that the method of flowchart 900 would likely be carried out numerous times during execution of the software application.

The method begins at step 902, in which software application 410 generates a function call directed to low-level graphics/audio functions 416. At step 904, it is determined whether or not the function call is intercepted by interception component. If no interception occurs, then processing proceeds to step 910, where the function call is handled by low-level graphics/audio functions 416 in a conventional manner. Processing of the function call then ends as indicated at step 916. However, if the function call has been intercepted, processing instead proceeds to step 906.

At step 906, interception component 412 identifies a graphics or audio object associated with the intercepted function call. As noted above, a graphics object may comprise a model, texture, image, parameter, or any other discrete set of graphics information associated with the intercepted function call and an audio object may comprise an audio file, a digital sound wave, or any other discrete set of audio information associated with the intercepted function call. The graphics or audio object may be part of the function call itself or may be addressed by or pointed to by the function call. For example, if the intercepted function call is a SetTexture function call to the Direct3D® API, the associated graphics object may consist of a texture pointed to by the SetTexture function call.

At step 908, business logic 414 determines if the identified object is associated with event criteria in business rule database 308. This step may include comparing the identified object, or a portion thereof, to a graphics or audio object, or portion thereof, stored in database 308. Alternatively, this step may include calculating a unique ID for the identified object and then comparing the unique ID for the identified object to a set of unique IDs stored in database 308. If the identified object is not associated with event criteria in database 308, then processing proceeds to step 910 where the function call is processed by low-level graphics/audio functions 416 in a conventional manner.

However, if the identified object is associated with event criteria in database 308, then a determination is made as to whether the event criteria has been met. The event criteria may be as straightforward as detecting the generation of the identified object or one or more other objects by the software application. Alternatively, the event criteria may be based on a measured impact of the identified object or one or more other objects, or some other criteria associated with the identified object or one or more other objects. If the event criteria has not been met, then processing proceeds to step 910 where the function call is processed by low-level graphics/audio functions 416 in a conventional manner.

However, if the event criteria has been met, then business logic 414 applies a business rule associated with the event as shown at step 914. Generally speaking, a business rule is any logic that, when applied within the context of application 410, causes the run-time environment 306 to perform, or the user to experience, a function that was not provided in the original application 410 source code. In this particular implementation, the application of the business rule comprises extracting information concerning the event and transmitting the extracted information to a remote location for use and/or viewing by another user. As will be described in more detail herein, extracting information associated with the event may include measuring or tracking information about one or more objects during run-time.

After the business rule has been applied at step 914, processing of the function call then ends as shown at step 916.

The foregoing description of the method of flowchart 900 assumes that each of the software components of run-time environment 306 have already been installed on a computer system. The method also assumes that software application 410 is executing on the computer system. Executing software application 410 encompasses both launching the application and interacting with the application through one or more user interfaces in a manner that causes the application to generate graphic and/or audio information.

Because the event criteria and associated business rules can be changed at any time by the system administrator or other entity, they provide a dynamic mechanism by which to enhance application 410. For example, the event criteria and business rules provided a dynamic mechanism by which to extract and report information concerning events, such as user achievements, occurring within the software application.

In one implementation, once business rules database 308 has been created or updated by the system administrator or other entity, a copy of database 308 is transferred to local memory of the computer system of run-time environment 306. The transfer may occur by transferring a copy of database 308 to a recordable computer useable medium, such as a magnetic or optical disc, and then transferring the computer useable medium to run-time environment 306. Alternatively, a copy of database 308 may be transferred via a data communication network, such as a local area and/or wide area data communication network. In yet another implementation, database 308 is not transferred to local memory of the computer system of run-time environment 306 at all, but is instead stored at a central location in a computing network, where it can be accessed by multiple run-time environments 306 using well-known network access protocols. However, these examples are not intended to be limiting and persons skilled in the relevant art(s) will appreciate that a wide variety of methods may be used to make database 308 available to run-time environment 306.

C. Dynamic User-Based Event Definition and Generation of Event Information

In one embodiment of the present invention, a business rule may be created by a user of the software application himself. Based on some user-generated input, the user may wish to define or declare a certain event. In this case, run-time environment 306 is configured to generate the event criteria (e.g., based on objects in the scene, their locations, proximities, and such). The user may further define the action that is to occur when the event criteria is met, based on a set of predefined or free-form set of actions. An example of a predefined action includes the display of a message. The user-generated event may then be transmitted to server side components 106 for selection by or distribution to one or more remote users. For example, such a user-generated event may be added to a database of business rules stored in central database 110 for selection by or distribution to one or more remote users by various means.

In an alternate embodiment of the present invention, the extraction of event information at step 914 of flowchart 900 includes the dynamic generation of objects or other content by the user of the software application. In accordance with such an embodiment, run-time environment 306 includes a component that allows a user to dynamically add objects or content during execution of the software application. For example, the user may be allowed to submit a message or add a new texture to a certain position in a scene. The dynamically-generated object or content is then transmitted to central database 110, where it may be selectively accessed by other users for enhancing their own versions of the software application. If a remote user chooses to use the dynamically-generated object or content, then that object or content will be presented within the remotely executing software application based on the same event criteria that caused the object or content to be created in the first place. The presentation of the dynamically-generated object or content to the remote user is thus its own business rule associated with its own event criteria.

D. Consumption of Dynamically-Generated Objects or Content Associated with an Event

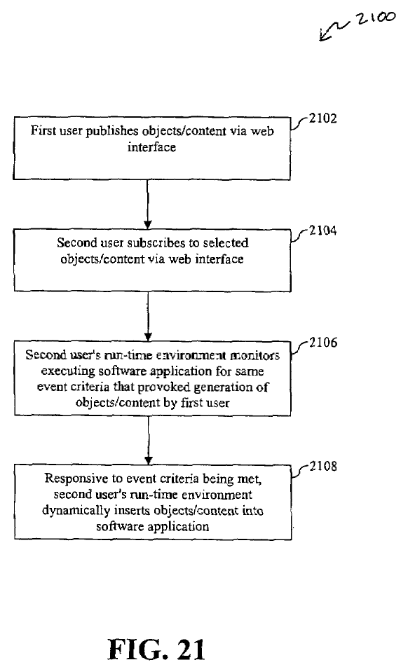

As noted above, in accordance with an embodiment of the present invention, a user may transmit dynamically-generated objects or content associated with an event occurring within a software application to central database 110, from where it may be selectively accessed by other users for enhancing their own versions of the software application. Further details concerning such an embodiment will now be described with reference to flowchart 2100 of FIG. 21.

In accordance with this embodiment, the user-generated objects or content may be “published” by a first user via a user-accessible interface, such as web interface 114, as shown at step 2102. The manner of publication is such that a second user can “subscribe” to selected published objects or content via the web interface as shown at step 2104. The second user may subscribe to individual objects or content or to a group of objects or content. Objects or content may be grouped according to events with which they are associated, the user that provided them, or some other grouping criteria.

Once objects or content have been subscribed to, the second user's run-time environment monitors the executing software application for the same event criteria that provoked the generation of the objects or content in the first user's run-time environment, as shown at step 2106, or alternatively for some other event criteria as specified by a user or system administrator. If the event criteria is met during execution of the application, the second user's run-time environment dynamically inserts the objects or content associated with that event into the executing software application as shown at step 2108, thereby enhancing the second user's experience within the software application. As described elsewhere herein, such dynamically added content may include a landmark or a “sticky” note providing hints or puzzle solutions at a specified location within a video game. However, this example is not intended to limit the present invention, and any type of user-generated objects or content may be published, subscribed to and dynamically inserted into an executing software application in accordance with embodiments of the present invention.

E. Distribution/Installation of Software Components to Run-Time Environment

As described above, an embodiment of the present invention facilitates the application of business rules to a software application executing on a computing device, thereby permitting the application to be enhanced in a dynamic manner that does not require modifying and recompiling the original application code. Additionally, because an embodiment of the invention can be implemented in run-time environment 306 using emulated libraries, the operation can be essentially transparent to the end user. Indeed, aside from the installation of the necessary software components (i.e., interception component 412, business logic 414, and optionally business rules database 308) in run-time environment 306, the end user need not take any proactive steps to link or interface the software application with an external software component.

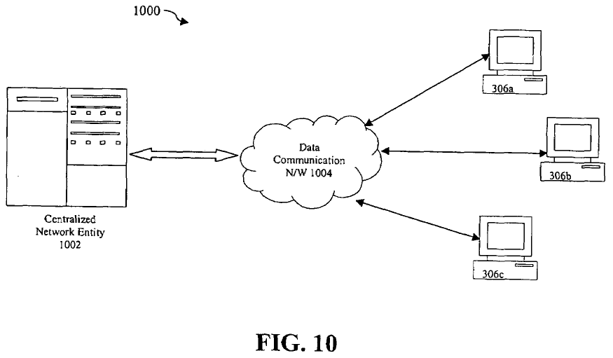

The distribution of the necessary software components to the end user device may be achieved in a variety of ways. For example, the software components may be distributed from a centralized entity to a number of run-time environments over a data communication network, such as the Internet. Such a system is illustrated in FIG. 10, in which a centralized network entity 1002 is shown communicating with a plurality of user run-time environments 306a, 306b and 306c over a data communication network 1004. By combining such network-based distribution with auto-installation software, the installation of such components on an end-user's computing device may be achieved in a manner that advantageously requires minimal end user intervention. Furthermore, since only a single copy of the run-time components is needed on the end user machine, one can also bundle those components with one or more applications 410.

In an implementation of the present invention, the business rules themselves are dynamic in the sense that an entity (for example, a publisher, retailer or service provider) can change them periodically to enhance a given application in different ways. Business rules can be changed or added by making modifications to business rules database 308. Copies of business rules database 308 or updates thereto may be distributed from a centralized network entity to multiple run-time environments 306 over a data communication network using a network system such as that shown in FIG. 10.

In an alternate implementation, copies of business rules database 308 are not distributed to run-time environments 306 at all but instead, business rules database 308 resides remotely with respect to run-time environments 306 and is accessed only when required via a data communication network, such as the Internet. For example, business logic rules database 308 may reside on a centralized network entity, such as a server, where it is accessed by computing devices associated with multiple run-time environments 306. Again, such a network configuration is illustrated in FIG. 10. This implementation is advantageous in that changes to the business rules need only be implemented once at the central server and need not be actively distributed to the multiple run-time environments 306.

In an implementation where interception component 412 comprises one or more emulated libraries, a determination may be made during installation of interception component 412 or at application run-time as to which libraries should be emulated. Consequently, different sets of libraries may be emulated for each software application that is to be dynamically enhanced. The determination may be based on the characteristics of the software application that is to be dynamically enhanced, upon some externally-provided metadata, or provisioned from the staging environment by one means or another.

F. Extracting Event Information Based on the Dynamic Measurement of Fine-Grain Properties of Objects

As described above, responsive to detection of an event, an embodiment of the present invention extracts information concerning the event and transmits the extracted information to a remote device for use and/or viewing by another user. In some cases, the determination of whether an event has occurred may involve measuring properties relating to a particular object or objects. In addition, once an event has occurred, the extraction of information associated with the event may involve tracking certain granular and complex data associated with the event. For example, where the software application is a video game of the “first-person shooter” type and the event is a final showdown with a monster or “boss”, one may wish to measure the amount of time a user spent fighting the monster. As another example, where the software application is a racing simulation and the event is racing on a particular racing track within the game, one may wish to measure the number of times that the user collided with a railing of the racing track. This event information can then be extracted and transmitted to a remote location for use and/or viewing by another user.

This section describes an embodiment of the invention that determines whether an event has occurred and/or extracts event information by dynamically tracking and determining the impact of objects rendered and/or referenced by a software application as the application executes in a computer, without requiring changes in the original application source code. For example, for a given object of interest, an embodiment of the invention tracks the object as the application executes, and measure properties such as those listed below:
a. Object size on screen.
b. Object orientation: The angle of the display of the object in relation to the viewer.
c. Collisions with other objects: Whether the object collides with another object.
d. Collusion/hiding or partial hiding relation between objects (including transparency).
e. Determination if an object is in view or partially in view (as a result of clipping of a scene).
f. Distance from view port/camera.
g. Distance between objects.
h. Object display time.
   The foregoing is not an exhaustive list. Other object properties will be apparent to persons skilled in the relevant art(s).

Measuring such object properties is useful for many software applications. Consider computer games, wherein the display is dynamic and changes according to the behavior of the game and the decisions made by the user. Because an embodiment of the invention tracks and measures object properties, including how objects interact, the invention makes it possible to run a computer game tournament, where such tournament is not an original element of the computer game. Consider an example where the tournament is a race, and a particular tree is designated as the finish line. By tracking the object(s) corresponding to the tree, the invention makes it possible to determine which user reaches the tree first. As a result, the invention makes it possible to add tournament play to existing computer games, without having to modify the source code of the games.

Another example includes centralized information sources and applications on top of them. Because an embodiment of the invention tracks and measures object properties, it makes it possible to know which users have achieved certain things in the game. For example, it may be determined which users in a massively multiplayer online role-playing game (MMORPG) possess a certain weapon within the game. By tracking the object(s) corresponding to the weapon and reporting it back to a centralized server or other remote device or devices, the information can be made available to other users/applications as well, allowing the creation of real-time virtual asset trading.

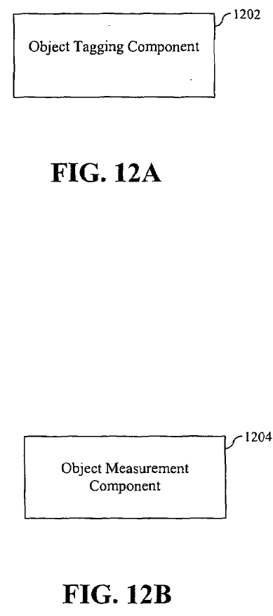

An embodiment of the present invention includes an optional object tagging component 1202 shown in FIG. 12A, and an object measurement component 1204 shown in FIG. 12B. In an embodiment, the object tagging component 1202 is a software component within staging environment 302 of FIG. 3, and may be a stand-alone component, or may be part of another component, such as indexing component 306. Also, object tagging component 1202 is optional, as one may not want necessarily to pre-designate objects to be measured, but may want to instead measure objects only if a particular event has occurred. Object measurement component 1204 is a software component within run-time environment 306, and may be a stand alone component, or may be part of another component, such as interception component 412 or business logic 414.

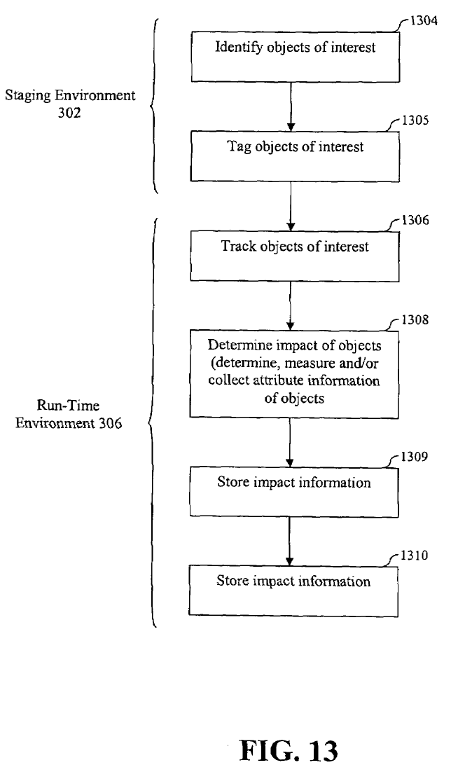

As described in detail below, object tagging component 1202 operates to tag certain objects, such as but not limited to certain objects that are indexed in staging environment information database 304. Object measurement component 1204 tracks and measures attributes of those tagged objects. Such operation shall now be described in greater detail with reference to a flowchart 1302 shown in FIG. 13. According to an embodiment, in flowchart 1302, steps 1304 and 1305 are performed in staging environment 302, and steps 1306, 1308, 1309 and 1310 are performed in run-time environment 306.

In step 1304, object tagging component 1202 identifies objects of interest. In an embodiment, such objects of interest are a subset of the objects stored in staging environment information database 304. In other embodiments, there may be objects of interest that are not stored in staging environment information database 304. In still other embodiments, the staging environment information database 304 includes rules providing criteria that objects must satisfy in order to be considered objects of interest, without identifying individual objects. An “object of interest” may be, for example, a graphical, audio or video object used in defining an event criteria or to provide information associated with an event, or any other object that one wishes to track and monitor, for whatever reason.

In step 1305, object tagging component 1202 tags the objects of interest. Such tagging of an object may be achieved in a number of ways, such as: (1) setting a flag in the object's entry in the staging environment information database 304; and/or (2) creating a new table, such as a new hash table, and storing in the table information identifying the object (such as a CRC of the object).

In an embodiment, object tagging component 1202 performs steps 1304 and 1305 augmenting/as-part-of interception component 404 and indexing component 406 as they are populating staging environment information database 304. Specifically, at the time that indexing component 406 identifies objects associated with function calls to low-level graphics/audio functions 408 (that were intercepted by interception component 404), and indexes such objects in staging environment information database 304, object tagging component 1202 also performs step 1304 (where it identifies objects of interest), and step 1305 (where it tags objects of interest).

Alternatively, object tagging component 1202 performs steps 1304 and 1305 after interception component 404 and indexing component 406 have populated staging environment information database 104 (specifically, after flowchart 700 of FIG. 7 has been performed). This can be used to allow batch logging of such objects during the execution of the applications in staging environment 302, while steps 1304, 1305 are performed by an administrator without interacting with the application itself, but rather by altering information in database 304.

In step 1306, object measurement component 1204 operating in run-time environment 306 tracks objects of interest, to thereby monitor objects of interest as the scenes rendered by the application evolve and change. In particular, object measurement component 1204 reviews the objects referenced in function calls directed to low-level graphics/audio functions 416 (such function calls having been intercepted by interception component 412, as described above), and determines whether any of those objects are objects of interest (i.e., by checking the staging environment information database 304, or by checking for information in the objects themselves, etc.). In an embodiment, once an object is initially identified as being an object of interest, subsequent tracking of that object in run-time environment 306 can be achieved by (1) inserting information into the object itself, indicating that the object is an object of interest; or (2) creating a proxy of the object, whereby future references to the object are directed to the proxy, instead of the object itself (the proxy would include a pointer or other reference to the underlying object, as well as information indicating that the object is an object of interest); or by other methods that will be apparent to persons skilled in the relevant art(s).

In step 1308, object measurement component 1204 determines the impact of the objects of interest. In embodiments, object measurement component 1204 performs step 1308 by determining, measuring and/or collecting information about the objects, such as the object size, orientation, collisions with other objects, whether the object is in view, distance of the object from other objects and from the camera, etc.

In step 1309, object impact information from step 1308 is saved in persistent storage.

In step 1310, the object information is used to determine if an event has occurred (see step 912 of flowchart 900) or is transmitted as part of event information (see step 914 of flowchart 900).

In an alternative embodiment, instead of (or in addition to) tracking pre-identified objects, object measurement component 1214 tracks and measures objects that satisfy pre-determined rules and/or criteria, where such rules and/or criteria may be stored in staging environment information database 304. In this embodiment, and as mentioned above, an administrator inserts into staging environment information database 304 such rules and/or criteria. Thereafter, in run-time environment 306, object measurement component 1214 determines whether objects referenced in intercepted function calls satisfy the rules and/or criteria. If the rules and/or criteria are satisfied, then object measurement component 1214 tracks and measures such objects as the application 410 executes in run-time environment 306. This alternative embodiment is also further described below.

### 1. Operation of Object Tagging Component

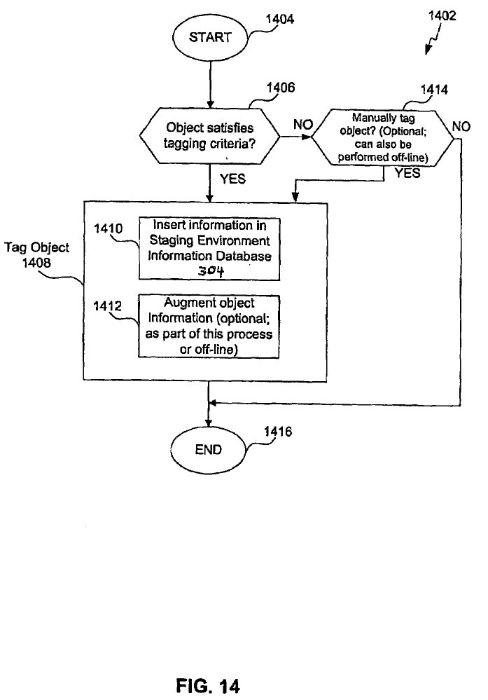

Flowchart 1402 in FIG. 14 represents the operation of object tagging component 1202 as it identifies objects of interest, and as it tags such objects of interest. In other words, flowchart 1402 shows in greater detail the operation of object tagging component 1202 as it performs steps 1304 and 1305 of FIG. 13.

Flowchart 1402 essentially describes the processing steps carried out by object tagging component 1202 with respect to the handling of a single graphics or audio function call generated by a single software application. Persons skilled in the relevant art(s) will readily appreciate that a software application will likely generate numerous such function calls, and thus that the method of flowchart 1402 would likely be carried out numerous times during execution of the software application. The method will now be described in part with continued reference to certain software components illustrated in FIG. 4 and described above in reference to that figure. However, persons skilled in the relevant art(s) will appreciate that the method of flowchart 1402 is not limited to that implementation.

In step 1406, object tagging component 1202 reviews each object referenced in a function call directed to low-level graphics/audio functions 416. This function call was generated by application 402 in staging environment 302, and was intercepted by interception component 404, in the manner described above. Object tagging component 1202 determines whether the object satisfies tagging criteria.

The tagging criteria define some of the objects that will be tracked and measured. In an embodiment, the tagging criteria are pre-defined by users and, accordingly, the tagging criteria are implementation- and application-dependent. The tagging criteria may pertain to any object properties, and may pertain to a single property or a combination of properties. For example, the tagging criteria may specify the minimum size object that will be tracked, and/or may specify that only objects of certain shapes and/or colors will be tracked. Other tagging criteria will be apparent to persons skilled in the relevant art(s) based on the teachings contained herein.

If the object satisfies the tagging criteria, then in step 1408 the object tagging component 1202 tags the object. By “tagging the object,” it is meant that the object is somehow marked or otherwise distinguished so that, in the future, the object can be identified as being an object of interest (i.e., as being an object that one wishes to track and measure). There are many ways of tagging the object. For example, object tagging component 1202 may set a flag or insert other tagging indicia into the object's entry in the staging environment information database 304 (see step 1410), or may create a new table, such as a new hash table, and insert information identifying the object (such as a CRC of the object) into the hash table (only tagged objects would be represented in this new table). Additionally, in embodiments, an opportunity may be provided to augment information on the object, such as providing a name or description of the object (see step 1412). This can be done manually by an administrator, for example, and can be part of the process of FIG. 14, or can be performed off-line.

Returning to step 1406, if object tagging component 1202 determines that the object does not satisfy the tagging criteria, then step 1414 is optionally performed. Step 1414 is performed only in embodiments that allow manually tagging of objects by users. Accordingly, in step 1414, object tagging component 1202 enables the user to indicate whether or not the object should be tagged. Step 1414 can be performed as part of the process of FIG. 14, or can be performed off-line. If the user indicates that the object should be tagged, then step 1408 is performed, as described above.

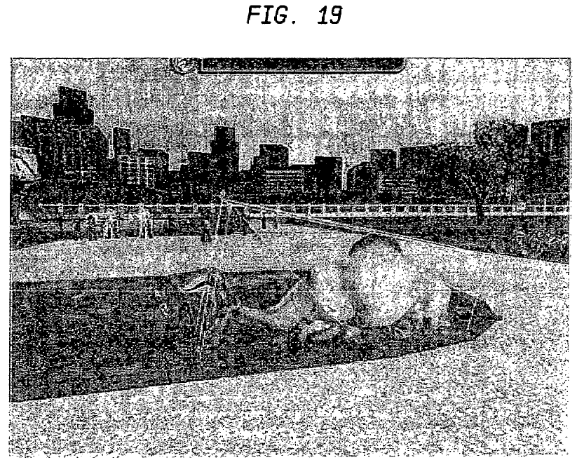

The manual tagging of objects in step 1414 may be performed, for example, by allowing the user to interact with the application 402 in a certain way (e.g., by a certain key combination). Interception component 404 may intercept such user inputs. In an embodiment, the interception component 404 may intercept key strokes that allow the user to:
a. Navigate between all objects or a subset of the objects on the screen (e.g., objects that meet certain criteria). Objects that the user is currently “selecting” can be highlighted by intercepting calls for their rendering by interception component 404 and altering such rendering with additional information. For example, this is shown in the example of FIG. 19, by the white boundary boxes around the camel).
b. Choose/Tag a certain object.
c. (Optionally) Pop-up an interactive form for the user to allow entering additional data about the tagged object.

In certain embodiments, step 1414 is not performed, in which case flowchart 1402 is performed entirely automatically by object tagging component 1202. In other embodiments, tagging of objects is performed entirely manually. In still other embodiments, flowchart 1402 is performed automatically with some user interaction, in the manner described above. In still other embodiments, flowchart 1402 is not performed at all and rules are defined to provide criteria for objects to be measured, without identifying individual objects.

### 2. Operation of Object Measurement Component

Referring again to flowchart 1302 in FIG. 13, it was described above that steps 1306, 1308, 1309 and 1310 are performed by an object measurement component 1204 in run-time environment 306. In an embodiment, such operation of object measurement component 1204 occurs during step 914 of flowchart 900 in FIG. 9. (The steps of flowchart 900 were described above, and that description is not repeated here).

As described above, during step 914, business logic 214 applies a business rule that is applicable to the object being processed (referred to above as the “identified object”). In particular, business logic 214 applies a business rule that causes information concerning an event occurring in the software application to be extracted and transmitted to a remote location. In an embodiment, the extraction of such information includes “measurement business rules” that, when applied, cause the object measurement component 1204 to determine, measure and/or collect attribute information on the identified object. (As noted above, object measurement component 1204 may be a separate component in run-time environment 306, or may be part of business logic 314.).

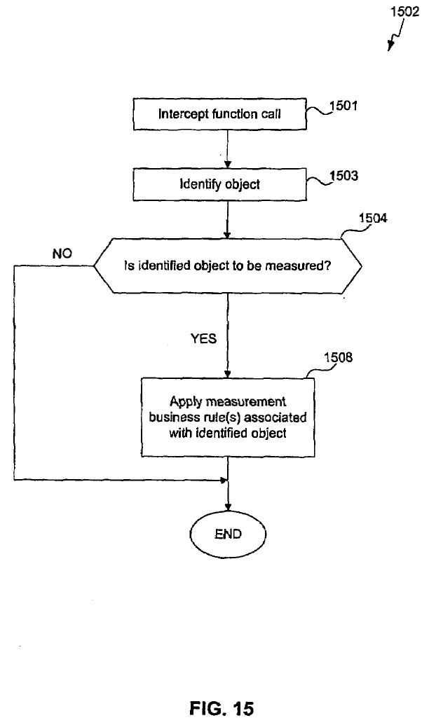

The operation of such an embodiment is represented by flowchart 1502 in FIG. 15. Flowchart 1502 includes steps 1501, 1503, 1504 and 1508, which collectively correspond to steps 1306, 1308, 1309 and 1310 of FIG. 13.

In step 1501, interception component 412 intercepts a call to low-level graphics/audio functions 416, and in step 1503 an object referenced by such intercepted function call is identified, in the manner described above.

In step 1504, the object measurement component 1204 determines whether the identified object is tagged. As explained above, if the object is tagged, then the object is one that we wish to monitor its progress, and measure its attributes. The operation of object measurement component 1204 in step 1504 depends on how the object tagging component 1202 tagged the identified object in step 1408 (described above). For example, object measurement component 1204 may: (1) check for a flag in the identified object's entry in database 308 or 304; and/or (2) determine whether the identified object is represented in a hash table dedicated to tagged objects. The object measurement component 1204 may perform one or more of these checks.

In an embodiment, once an object is identified as an object of interest as described above, it can be marked in the run-time environment 306, to facilitate keeping track of it, as it is being processed by multiple functions and libraries during a certain 3D scene buildup. This can be accomplished, for example, by inserting tagging indicia into the object itself. Alternatively, this can be accomplished by creating a proxy of the object (whereby future references to the object are directed to the proxy), and inserting tagging indicia into the proxy (the proxy would also include a pointer or other reference to the underlying object). Other techniques for tagging objects will be apparent to persons skilled in the relevant art(s).

If the identified object is tagged, then step 1508 is performed. In step 1508, the object measurement component 1204 performs one or more measurement business rules. Some of these measurement business rules may apply to all objects, or all tagged objects while others may be associated with only certain tagged objects. As a result of applying such measurement business rules, the object measurement component 1204 operates to determine the impact of the tagged object by, for example, determining, measuring and/or collecting attribute information on the identified object. Application of such measurement business rules may also cause the transfer of such object attribute information to a server or other designated location(s), in either real-time or batch mode, or a combination of real-time/batch mode.

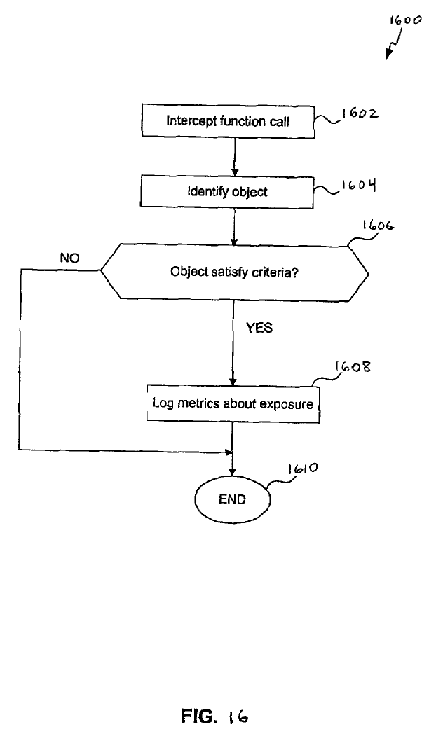

FIG. 16 illustrates an alternative operational embodiment 1600 of object measurement component 1204. In this alternative embodiment, instead of (or in addition to) tracking pre-identified objects, object measurement component tracks and measures objects that satisfy pre-determined rules and/or criteria, where such rules and/or criteria may be stored in staging environment information database 304.

Specifically, in step 1602, interception component 412 intercepts a call to low-level graphics/audio functions 416, and in step 1604 an object referenced by such intercepted function call is identified, in the manner described above.

In step 1606, object measurement component 1204 determines whether the object satisfies certain pre-determined rules or criteria. Such rules and/or criteria are described elsewhere herein.

In step 1608, if the object satisfies the rules/criteria, then the object measurement component 1204 logs metrics about the object (i.e., determines the impact of the object). Such information is stored, and may be optionally transferred to a server or other designated component(s) in real-time or in batch mode.

### 3. Determining the Impact of a Tagged Object

In this section, steps 1508 and 1606 are described in more detail.

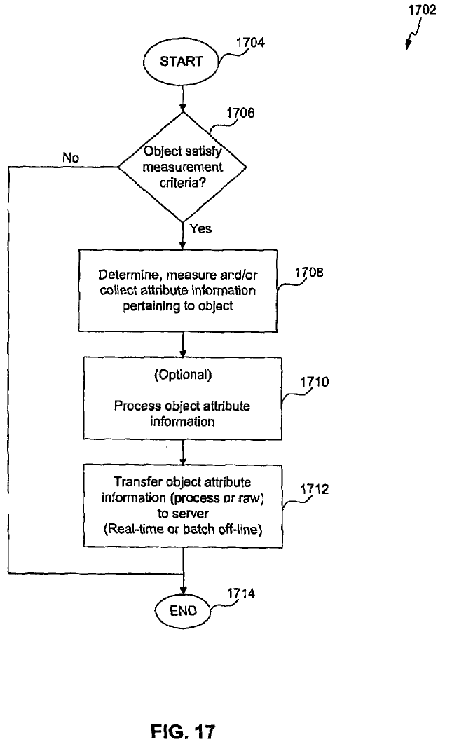

In steps 1508 and 1606, object measurement component 1204 determines the impact of an object being tracked. In an embodiment, the operation of object measurement component 1204 in performing step 1508 and 1606 is represented by flowchart 1702 in FIG. 17.

Flowchart 1702 essentially describes the processing steps carried out by object measurement component 1204 with respect to processing an object of interest that was referenced in a graphics or audio function call generated by software application 410. Persons skilled in the relevant art(s) will readily appreciate that software application 410 will likely generate numerous such function calls. Also, each such function call may reference numerous objects. Thus, the method of flowchart 1702 would likely be carried out numerous times during execution of the software application 410. The method will now be described in part with continued reference to certain software components illustrated in FIG. 4 and described above in reference to that figure. However, persons skilled in the relevant art(s) will appreciate that the method of flowchart 1702 is not limited to that implementation.

In step 1706, object measurement component 1204 determines whether the object satisfies measurement criteria. As reflected by step 1706, in certain embodiments, the attributes of an object are measured only in frames wherein the tagged object satisfies measurement criteria. For example, it may not be interesting to measure a tagged object in those frames or scenes where its relative size is less than a minimum. The criteria comprise one or more object properties that must be satisfied by the object in a given frame in order for the object to be measured in that frame.

In an embodiment, the measurement criteria are pre-defined and, accordingly, the measurement criteria are implementation and application dependent. The measurement criteria may pertain to any object properties, and may pertain to a single property or a combination of properties. For example, the measurement criteria may be based on object size (for example, an object less than a certain size will not be measured), angle (for example, only objects within a minimal and maximal angle will be measured), collision/obfuscation with another object (for example, an object will not be measured if the collusion area is greater than a maximum), hiding or partial hiding by another object (for example, an object will not be measured if it is hidden by more than a maximum percentage), distance from camera (for example, an object will not be measured if the distance between the object and the viewport is greater than a maximum), distance between objects (for example, an object will not be measured if it is too close to another object), and/or object display time (for example, an object will not be measured until it appears in a certain number of consecutive frames). The above is not an exhaustive list. Other measurement criteria will be apparent to persons skilled in the relevant art(s) based on the teachings contained herein.

It is noted that step 1706 is optional. Some embodiments do not include step 1706, in which case attributes of objects of interest are always measured. Alternatively, all objects the application is trying to render may also be measured.

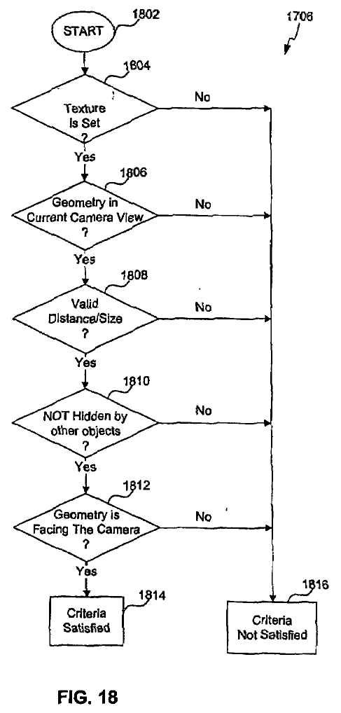

FIG. 18 illustrates the operation of object measurement component 1204 when performing step 1706, according to an embodiment of the invention. FIG. 18 is provided for purposes of illustration, and is not limiting. Other processes for implementing step 1706 will be apparent to persons skilled in the relevant art(s) based on the teachings contained herein.

The process in FIG. 18 includes a particular combination (by way of example) of measurement criteria that must be satisfied in order for the tagged object to be measured. Such measurement criteria are represented by steps 1804, 1806, 1808, 1810 and 1812, the substance of which will be apparent to persons skilled in the relevant art(s). If all of these criterions are satisfied, then in step 1814 the object measurement component 1204 determines that the measurement criteria is satisfied. Otherwise, in step 1816, the object measurement component 1204 determines that the measurement criteria are not satisfied.

In other embodiments, the measurement criteria are based on a different set of object attributes. Also, in other embodiments, satisfying a subset of the measurement criterions may be sufficient to enable the object measurement component 1204 to determine that the criteria is satisfied (step 1814).

Returning to FIG. 17, if the object measurement component 1204 determines in step 1706 that the tagged object satisfies the measurement criteria, then step 1708 is performed. In step 1708, object measurement component 1204 determines, measures and/or collects attribute information pertaining to the tagged object.

In step 1710, in an embodiment, object measurement component 1204 processes the object attribute information from step 1708. For example, consider the case where the size of the tagged object is measured, and it is of interest to know the number of times the size of the tagged object falls within a first size range, a second size range, a third size range, etc. Such information may be useful in the in-game advertising field, where advertising royalties are based on exposure of advertisements in scenes rendered by the computer game. In this example, object measurement component 1204 in step 1708 determines which size range the tagged object falls into for the current frame, and then increments the counter associated with that size range.

In embodiments, the object measurement component 1204 may perform similar range calculations with regard to the object's angle, the object's distance from camera, the distance between objects, the object's display time, as well as other object properties, as will be appreciated by persons skilled in the relevant art(s) based on the teachings contained herein.

In embodiments, step 1710 is not performed by object measurement component 1204 in run-time environment 306. Instead, step 1710 is performed at the server and/or other designated components remote to run-time environment. In other embodiments, processing of step 1710 is shared between object measurement component 1204 and the server and/or other designated components remote to run-time environment.

In step 1712, object measurement component 1204 transfers the object attribute information to the server and/or other devices remote to run-time environment. As discussed, step 1712 may be performed in real-time or in batch. Object measure component 1204 may transfer the raw data from step 1708, or the processed data from step 1710, or a combination of the raw and processed data.

### 4. Measurement Examples

As described above, object measurement component 1204 in step 1708 determines, measures and/or collects attribute information pertaining to the tagged object. Embodiments for determining, measuring and/or collecting such attribute information are described in this section. These embodiments are provided for purposes of illustration, and not limitation. Other techniques for determining, measuring and/or collecting object attribute information will be apparent to persons skilled in the relevant art(s).

For illustrative purposes, the following description is made with reference to graphical objects. However, the invention is not limited to graphics and covers any type of media used in an application, such as sound, video, etc. Determining, measuring and/or collecting attribute information for other types of objects will be apparent to persons skilled in the relevant art(s).

Measurements may be performed between objects (for example, the distance between objects, or the collision between objects, or the collusion of one object by the other), or on the absolute value of an object (for example, the size or angle of an object, or the distance of the object from the viewport). As will be appreciated, such measurements may be made by making calls to low-level graphics/audio functions 416. Accordingly, the following describes, by way of example, how the tasks can be accomplished using DirectX. However, the invention is not limited to this example embodiment. Determining, measuring and/or collecting attribute information for objects using other than DirectX function calls will be apparent to persons skilled in the relevant art(s).

Other object attribute information may be obtained from the calls intercepted by interception component 412, or via the operating system. Determining object attribute information from these sources, as well as other sources, will be apparent to persons skilled in the relevant art(s).

Note that for all examples illustrated below for measurement, such measurement can occur on an every frame basis, or based on a periodical (e.g., every 10^{th} frame), to alleviate performance issues. Obviously, such periodical measurement has an impact on the granularity of exposure times reported.

### a. Collisions Between Objects

Interaction and collision between objects can be measured in many ways. There are more accurate and less accurate methods, with associated computation performance issues.

One method is to cross correlate over all polygons that are building the objects and determine if and what properties (x,y,z) are related to collisions between the object geometries. This approach requires substantial computational resources.

An alternative method involves bounding the objects within a simpler geometric body (such as a box), and performing a collision check on only the bounding boxes. In DirectX, bounding box calculation is a relatively straightforward process using the D3DXComputeBoundingBox API. The returned position vectors are used as data for the collision detection process. The bounding box collision detection process is simpler than when performed at the polygon or vertex level.

Another alternative approach is to project the 3D representation into 2D space using the DirectX D3DXVec3Project API, and then perform the collision detection process in the 2D world.

### b. In-View Check

“In-view” check determines if an object is located within the viewport. In-view check is interesting because some applications render objects that are not visible from the viewport.

Similar to the collision check, the in-view check can be done in the 3D world or in the 2D world. The in-view check can be performed with regard to the frustum and/or the viewport. The in-view check returns outside, inside or intersection. Like the collision check, the 3D in-view check can be done using the bounding box approach, or by projecting the 3D representation into 2D space.

An example approach uses the DirectX ProcessVertices API and/or D3DXVec3Project API to project the vertices from 3D to 2D. Then, the projected vertices are examined to determine whether the object is inside or outside the viewport.

### c. Distance

Distance can be calculated from cameras or between objects. Distance units are relative to the game, but can be normalized to enable comparisons between games.

Distance is calculated by measuring the length between the center of the object geometry and the camera position. Alternatively, distance is calculated between the centers of object geometries. In DirectX, this measurement can be performed using the sqrt function on the sum of dx²+dy²+dz².

A special case is where the tagged object is being reflected by a mirror or lake (or another reflecting body), and the real distance to the object is not the distance to the mirror. In such cases, there is a need to take into account the existence of a render target. If there is a render target for the tagged object, then the distance is calculated with regard to that render target.

### d. Size

All elements that are displayed in the viewport have size. In an embodiment, an object's size is measured by projecting the 3D representation of the object into 2D space. Then, the 2D projected size within the viewport is calculated.

Alternatively, the bounding box approach can be used. Specifically, the object's size is measured by projecting the 3D bounding box, instead of the object itself. The 2D size calculations are then performed on the projected 2D bounding box. This approach is less accurate, but is also less computationally demanding.

Projection from 3D to 2D in DirectX can be done by using the ProcessVertices and D3DXVec3Project APIs.

After projecting the bounding box points from 3D to 2D, the bounding box of the projected 2D points is again calculated. Then, the area of this bounding box is calculated as the percentage from the total viewport size.

### e. Occlusion

In the 3D world, objects have a z axis value that can be covered or partially hidden by other objects.

In order to determine the displayed area of an object, there is a need to deduct those areas of the object that are being hidden by other non-transparent objects. In the case of objects that are partially transparent, the decision whether to deduct the covered area or not is based on the threshold levels of the transparency properties. Such properties include, but are not limited to: alpha channel value, blending function and drawing order.

In order to measure an object's covered area, all objects that might have a cover potential are identified. Next, the cover contribution of each of these objects is calculated.

An object has cover potential if (1) the object collides to some extent with the tagged object; (2) the object is closer to the viewpoint (camera) than the tagged object; and (3) the object is not transparent.

The covered area is measured by projecting both the object with cover potential and the tagged object from 3D to 2D. Then, the area that is common to both objects is calculated.

An alternative approach is to operate as just described, but with bounding boxes, instead of the actual object geometries. This approach is less accurate, but also less computationally demanding.

Another alternative approach is to use the z-buffer mechanism built into DirectX and the graphics card. When detecting an object of interest, one may check the z-buffer before and after applying the object. The differences in the z-buffer depth map provide us with the contour of the 2D application of the 3D object. That 2D application can be compared to the rendering of the object on a clean z-buffer, to determine if it is hidden by objects that were previously rendered, and to what extent. At the end of the scene creation, the z-buffer may be checked again, in reference to the area previously identified as corresponding to the 2D application of the object of interest. If any of those pixels in the end-of-scene depth map have changed from the object was rendered, it means that the object may have been further hidden by other objects.

### f. Angle (Orientation)

In an embodiment, the angle between objects, or the angle between an object and the camera, is treated as the angle between the objects' normal vectors.

An example method of determining the angle in which the object is being displayed involves calculating the face normal of the bounding box using a cross product function (D3DXVec3Cross). Then, a dot product function (D3DXVec3Dot, where the input is the three plane vertices) is executed between the camera look at vector and the bounding box normal.

The result of this operation is the angle between the camera look at vector and the bounding box normal. In an embodiment, the face normal is transformed with the world matrix using the DirectX D3DXVec3TransformNormal API before this angle is calculated.

### 5. Example Embodiment of Calculating Measurements in Real Time Using DirectX

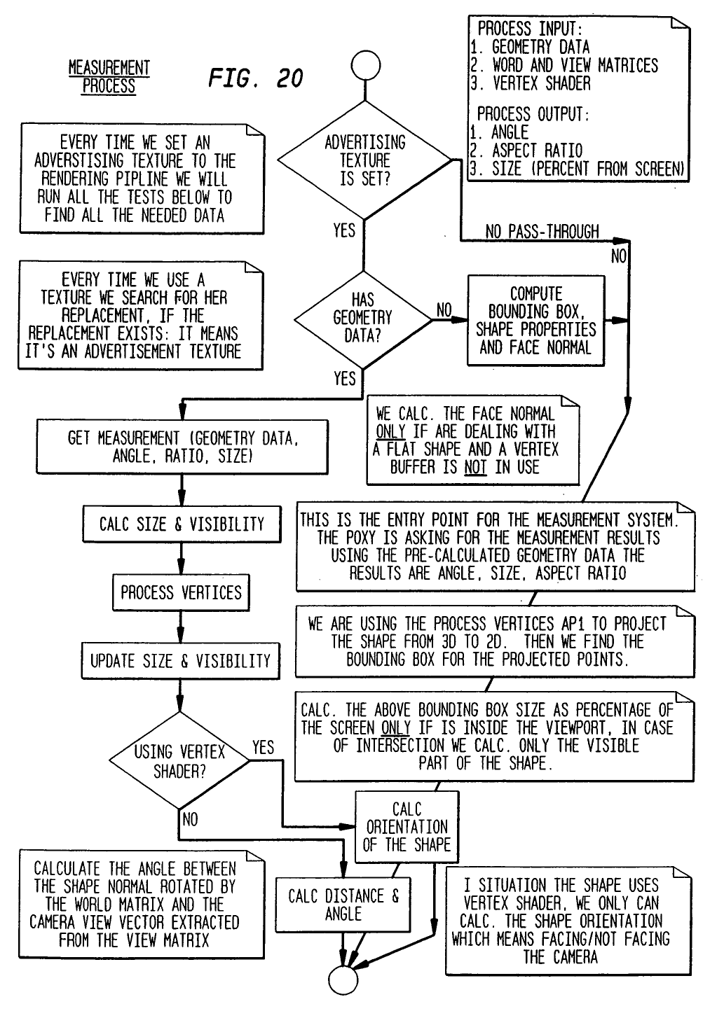

This section describes an example embodiment for measuring exposure of an object using DirectX (also see, for example, the process in FIG. 20). This example is provided for purposes of illustration, and not limitation. The DirectX functions mentioned herein are well known and are described in numerous places, such as but not limited to http://msdn.microsoft.com.

In order to measure exposure, the following DirectX functions are hooked:

IDirect3DDevice9::DrawlndexedPrimitive; and

IDirect3DDevice9::DrawPrimitive.

When the game calls those functions, the hooked functions are called instead. The hooked functions may eventually forward the calls to the original function (depending on the business rules).

In an embodiment, the following steps are performed for calculating measurements:

(1) First check if this texture is a texture of interest (by checking the database of tagged objects from the staging environment, or objects that satisfy certain criteria, as described above). An object that was marked of interest previously may contain that knowledge already in its private data, to be retrieved by using GetPrivateData.

The private data may have been set when identifying the texture when it is loaded. There are additional ways to mark an object, and private data is used only as an example.

(2) If the texture is not of interest, continue without any additional processing.

(3) Verify that the texture has geometry data. Geometry data helps calculate measurements and should be created at least one time for the texture lifetime. Once calculated it can be save. In one example it can be saved in the texture private data.

(4) If the texture private data does not hold the geometry data, calculate the following and store it in the private data:
a. Bounding Box: A bounding box is calculated by calling D3DXComputeBoundingBox. The function will return two 3D points that specify the location of the object
b. Face Normal: call D3DXVec3Cross in order to determine the cross-product of the two 3D vectors
c. Vertex Shader Version: check the version of Vertex Shader used if any by calling pIDirect3DDevice→GetVertexShader
d. 2D or 3D: verify if the object is 2D or 3D by checking if the bounding box volume.
e. In other examples, additional information can be calculated and calculations can be done in other ways.

(5) Once all the above information is available, calculate the actual exposure of a texture:
a. Call pIDirect3DDevice→ProcessVertices: Create 2D projection of the 3D geometry shape
b. Compute bounding box on 2D using D3DXComputeBoundingBox
c. Call pIDirect3DDevice→GetViewport to get the screen resolution and check area of 2D bounding box inside Viewport. Take into account only the portion of the object 2D bounding box inside the viewport. As a result, calculate the size of the object that is visible in the screen.
d. Using pIDirect3DDevice→GetTransform in order to get the object orientation and world orientation in order to calculate the object angle.

The information collected above can be calculated per texture per frame and is used by the measurements logic in order to calculate the total exposure of textures inside an application.

### III. Example Computer System Implementation

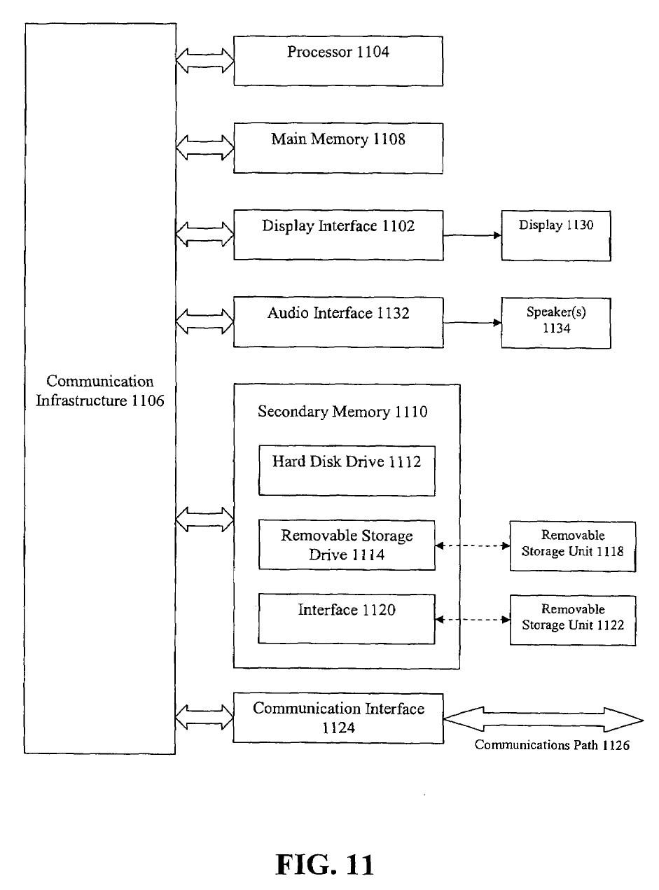

FIG. 11 depicts an example computer system 1100 that may be utilized to implement local device 102, remote devices 108a, 108b and 108c (with reference to FIG. 1) as well as staging environment 302 or run-time environment 306 (with reference to FIG. 3). However, the following description of computer system 1100 is provided by way of example only and is not intended to be limiting. Rather, as noted elsewhere herein, each of the foregoing devices may comprise a server, a console, a personal digital assistant (PDA), a cellular phone, or any other computing device that is capable of executing software applications and displaying associated application-generated graphics and audio information to an end-user.

As shown in FIG. 11, example computer system 1100 includes a processor 1104 for executing software routines. Although a single processor is shown for the sake of clarity, computer system 1100 may also comprise a multi-processor system. Processor 1104 is connected to a communication infrastructure 1106 for communication with other components of computer system 1100. Communication infrastructure 1106 may comprise, for example, a communications bus, cross-bar, or network.

Computer system 1100 further includes a main memory 1108, such as a random access memory (RAM), and a secondary memory 1110. Secondary memory 1110 may include, for example, a hard disk drive 1112 and/or a removable storage drive 1114, which may comprise a floppy disk drive, a magnetic tape drive, an optical disk drive, or the like. Removable storage drive 1114 reads from and/or writes to a removable storage unit 1118 in a well known manner. Removable storage unit 1118 may comprise a floppy disk, magnetic tape, optical disk, or the like, which is read by and written to by removable storage drive 1114. As will be appreciated by persons skilled in the relevant art(s), removable storage unit 1118 includes a computer usable storage medium having stored therein computer software and/or data.

In an alternative implementation, secondary memory 1110 may include other similar means for allowing computer programs or other instructions to be loaded into computer system 1100. Such means can include, for example, a removable storage unit 1122 and an interface 1120. Examples of a removable storage unit 1122 and interface 1120 include a program cartridge and cartridge interface (such as that found in video game console devices), a removable memory chip (such as an EPROM or PROM) and associated socket, and other removable storage units 1122 and interfaces 1120 which allow software and data to be transferred from the removable storage unit 1122 to computer system 1100.

Computer system 1100 also includes at least one communication interface 1124. Communication interface 1124 allows software and data to be transferred between computer system 1100 and external devices via a communication path 1126. In particular, communication interface 1124 permits data to be transferred between computer system 1100 and a data communication network, such as a public data or private data communication network. Examples of communication interface 1124 can include a modem, a network interface (such as Ethernet card), a communication port, and the like. Software and data transferred via communication interface 1124 are in the form of signals which can be electronic, electromagnetic, optical or other signals capable of being received by communication interface 1124. These signals are provided to the communication interface via communication path 1126.

As shown in FIG. 11, computer system 1100 further includes a display interface 1102 which performs operations for rendering images to an associated display 1130 and an audio interface 1132 for performing operations for playing audio content via associated speaker(s) 1134.

As used herein, the term “computer program product” may refer, in part, to removable storage unit 1118, removable storage unit 1122, a hard disk installed in hard disk drive 1112, or a carrier wave carrying software over communication path 1126 (wireless link or cable) to communication interface 1124. A computer useable medium can include magnetic media, optical media, or other recordable media, or media that transmits a carrier wave or other signal. These computer program products are means for providing software to computer system 1100.

Computer programs (also called computer control logic) are stored in main memory 1108 and/or secondary memory 1110. Computer programs can also be received via communication interface 1124. Such computer programs, when executed, enable the computer system 1100 to perform one or more features of the present invention as discussed herein. In particular, the computer programs, when executed, enable the processor 1104 to perform features of the present invention. Accordingly, such computer programs represent controllers of the computer system 1100.

Software for implementing the present invention may be stored in a computer program product and loaded into computer system 1100 using removable storage drive 1114, hard disk drive 1112, or interface 1120. Alternatively, the computer program product may be downloaded to computer system 1100 over communications path 1126. The software, when executed by the processor 1104, causes the processor 1104 to perform functions of the invention as described herein.

### IV. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method for dynamically sharing information indicative of the progress or performance of a user within a software application executing on a local device, comprising:
monitoring the software application during execution to determine if an event has occurred, wherein the event is indicative of the progress or performance of the user within the software application; and
responsive to a determination that the event has occurred, extracting information associated with the event and transmitting the extracted information from the local device for further processing.

2. The method of claim 1, wherein monitoring a behavior of the software application during execution comprises monitoring objects referenced or rendered by the application.

3. The method of claim 2, wherein monitoring objects referenced or rendered by the application comprises intercepting function calls generated by the application.

4. The method of claim 1, wherein determining if an event has occurred comprises determining if one or more event criteria have been met.

5. The method of claim 4, further comprising receiving the event criteria from a source external to the local device.

6. The method of claim 1, wherein extracting information associated with the event comprises:
permitting the user to generate content associated with the event.

7. The method of claim 1, wherein transmitting the extracted information from the local device for use or viewing by another user comprises:
transmitting the extracted information to at least one server for use in providing community features to one or more remote users.

8. The method of claim 7, further comprising:
permitting the user to generate content associated with the extracted information after the extracted information has been transmitted to the at least one server.

9. The method of claim 1, further comprising:
permitting the user to define an event; and
extracting information associated with the user-defined event and transmitting the extracted information from the local device for use or viewing by another user.

10. A system comprising:
a processor; and
a memory in communication with the processor, the memory storing a plurality of instructions for directing the processor to:
execute a software application;
monitor a behavior of the software application during execution to determine if an event has occurred, wherein the event is indicative of the progress or performance of the user within the software application; and
extract information associated with the event and transmit the extracted information from the system responsive to a determination that the event has occurred.

11. The system of claim 10, wherein the plurality of instructions for directing the processor to monitor a behavior of the software application during execution includes:
a plurality of instructions for directing the processor to monitor objects referenced or rendered by the application.

12. The system of claim 11, wherein the plurality of instructions for directing the processor to monitor objects referenced or rendered by the application includes:
a plurality of instructions for directing the processor to intercept function calls generated by the application.

13. The system of claim 10, wherein the plurality of instructions for directing the processor to determine if an event has occurred includes:
a plurality of instructions for directing the processor to determine if one or more event criteria have been met.

14. The system of claim 13, further comprising:
a plurality of instructions stored in the memory for directing the processor to receive the event criteria from a source external to the system.

15. The system of claim 10, wherein the plurality of instructions for directing the processor to extract information associated with the event includes:
a plurality of instructions for directing the processor to permit the user to generate content associated with the event.

16. The system of claim 10, wherein the plurality of instructions for directing the processor to transmit the extracted information from the system includes:
a plurality of instructions for directing the processor to transmit the extracted information to at least one server for use in providing community features to one or more remote users.

17. The system of claim 10, further comprising:
a plurality of instructions stored in the memory for directing the processor to:
permit the user to define an event; and
extract information associated with the user-defined event and transmit the extracted information from the local device for use or viewing by another user.

18. A method for providing community features associated with a software application, comprising:
storing event information received from a plurality of remotely-executing instances of the software application in a database, wherein the event information is inferentially derived through monitoring the execution of the remotely-executing instances of the software application; and
executing an application that facilitates access to the event information by a plurality of remote users.

19. The method of claim 18, wherein executing an application comprises executing a Web interface.

20. The method of claim 18, wherein executing an application comprises executing a community features engine.

21. The method of claim 18, wherein executing an application comprises providing leader boards or a high score table based on the event information.

22. The method of claim 18, wherein executing an application comprises permitting two or more of the plurality of remote users to compete in a tournament.

23. The method of claim 18, wherein executing an application comprises permitting league play between two or more of the plurality of remote users.

24. The method of claim 18, wherein executing an application comprises permitting a remote user to access event information for use in augmenting a web-page.

25. The method of claim 18, wherein storing the event information comprises storing user-generated content and wherein executing an application comprises permitting a remote user to access the user-generated content for dynamically enhancing a remotely-executing instance of the software application.

26. The method of claim 18, wherein executing an application comprises permitting a first remote user to generate content associated with the event information.

27. The method of claim 26, wherein executing an application further comprises permitting the first remote user to publish the generated content and a second remote user to subscribe to the content.

28. A system for providing community features associated with a software application, comprising:
a database configured to store event information received from a plurality of remotely-executing instances of the software application, wherein the event information is inferentially derived through monitoring the execution of the remotely-executing instances of the software application; and
at least one server configured to execute an application that facilitates access to the event information by a plurality of remote users.

29. The system of claim 28, wherein the application comprises a Web interface.

30. The system of claim 28, wherein the application comprises a community features engine.

31. The system of claim 28, wherein the application is configured to provide leader boards or a high score table based on the event information.

32. The system of claim 28, wherein the application is configured to permit two or more of the plurality of remote users to compete in a tournament.

33. The system of claim 28, wherein the application is configured to permit league play between two or more of the plurality of remote users.

34. The system of claim 28, wherein the application is configured to permit a remote user to access event information for use in augmenting a web-page.

35. The system of claim 28, wherein the event information includes user-generated content and wherein the application is configured to permit a remote user to access the user-generated content for dynamically enhancing a remotely-executing instance of the software application.

36. A method for dynamically-enhancing an instance of a software application executing on a local device, comprising:
receiving information associated with the progress or performance of a remote user in a remotely-executing instance of the software application; and
dynamically augmenting graphics or audio content generated by the locally-executing instance of the software application based on the received information.

37. The method of claim 36, wherein receiving information comprises receiving content created by the remote user and wherein dynamically augmenting graphics or audio content generated by the locally-executing instance of the software application comprises inserting the received content into a graphics or audio object rendered or referenced by the locally-executing instance of the software application.

38. A system comprising:
a processor; and
a memory in communication with the processor, the memory storing a plurality of instructions for directing the processor to:
execute an instance of a software application;
receive information indicative of the progress or performance of a remote user in a remotely-executing instance of the software application; and
dynamically augment graphics or audio content generated by the locally-executing instance of the software application based on the received information.

39. The system of claim 38, wherein the plurality of instructions for directing the processor to receive information includes a plurality of instructions for directing the processor to receive content created by the remote user and
wherein the plurality of instructions for directing the processor to dynamically augment graphics or audio content generated by the locally-executing instance of the software application includes a plurality of instructions for directing the processor to insert the received content into a graphics or audio object rendered or referenced by the locally-executing instance of the software application.
